(19) United States
(12) Patent Application Publication
(10) Pub. No.: US 2004/0032918 A1
(43) Pub. Date: Feb. 19, 2004

(54) Communication method, system and apparatus utilizing burst symbol cycles

(76) Inventors: Gadi Shor, Tel-Aviv (IL); David Yaish, Tel-Aviv (IL); Yaron Knobel, Givat-Shmuel (IL); David Meshulam, Hod-Hasharon (IL)

Correspondence Address: BROWN, RAYSMAN, MILLSTEIN, FELDER & STEINER LLP, 900 THIRD AVENUE, NEW YORK, NY, 10022, US

(21) Appl. No.: 10/389,789

(22) Filed: Mar. 17, 2003

Related U.S. Application Data
(60) Provisional application No. 60/404,070, filed on Aug. 16, 2002.

(51) Int. Cl. H04L 27/08

(52) U.S. Cl. 375/345

(57) ABSTRACT

The present invention provides methods and systems for communication, including UWB based wireless and wired communication, in which information is transmitted utilizing a continuous series of burst symbol cycles, each burst symbol cycle including an ON period during which a number of chips representing a bit of information are transmitted using anultra-wide band signal, and an OFF period during which no signal is transmitted, providing advantages that can include scalability, adaptability and flexibility. Systems are provided that utilize the burst symbol cycle transmission technique in providing wireless and wired communication between multiple digital devices in a local area.

### RELATED APPLICATIONS

This application claims priority to U.S. Provisional Application No. 60/404,070 filed on Aug. 16, 2002, entitled, “Communication Method, System and Apparatus Utilizing Burst Symbol Cycles,” and to U.S. Provisional Application No. ______, Attorney Docket No. 5579/1A, filed on Feb. 28, 2003, entitled, “Communication Method, System and Apparatus Utilizing Burst Symbol Cycles,” both of which applications are hereby incorporated herein by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates in general to communication methods, systems, and apparatuses, and in particular to ultra-wide band based wireless communication methods, systems, and apparatuses.

The demand for short to medium range, high speed connectivity for multiple digital devices in a local environment continues to rise sharply. For example, many workplaces and households today have many digital computing or entertainment devices such as desktop and laptop computers, television sets and other audio and video devices, DVD players, cameras, camcorders, projectors, handhelds, and others. Multiple computers and television sets, for instance, have become common in American households. In addition, the need for high speed connectivity with respect to such devices is becoming more and more important. These trends will inevitably increase even in the near future.

As the demand for high speed connectivity increases along with the number of digital devices in typical households and workplaces, the demand for wireless connectivity naturally grows commensurately. High-speed wiring running to many devices can be expensive, awkward, impractical and inconvenient. High speed wireless connectivity, on the other hand, offers many practical and aesthetic advantages, which accounts the great and increasing demand for it. Ideally, wireless connectivity in a local environment should provide high reliability, low cost, low interference caused by physical barriers such as walls or by co-existing wireless signals, security, and high speed data transfer for multiple digital devices. Existing narrowband wireless connectivity techniques do not provide such a solution, having problems such as high cost, unsatisfactory data transfer rates, unsatisfactory freedom from signal and obstacle related interference, unsatisfactory security, and other shortcomings. In fact, the state of the art does not provide a sufficiently satisfactory solution for providing high speed wireless connectivity for multiple digital devices in a local environment.

The state of the art in wireless connectivity generally includes utilization of spread spectrum systems for various applications. Spread spectrum techniques, which spread a signal over a broad range of frequencies, are known to provide high resistance against signal blocking, or “jamming,” high security or resistance against “eavesdropping, ” and high interference resistance. Spread Spectrum techniques have been used in systems in which high security and freedom from tampering is required. Additionally, Code Division Multiple Access (CDMA), a spread spectrum, packet-based technique, is used in some cellular phone systems, providing increased capacity in part by allowing multiple simultaneous conversation signals to share the same frequencies at the same time.

Known spread spectrum and modulation techniques, including CDMA techniques, direct sequence spread spectrum (DSSS) techniques, time hopping spread spectrum (THSS) techniques, and pulse position modulation (PPM) techniques, do not satisfactorily provide wireless connectivity in a local environment, including high reliability, low cost, low interference, security, and high speed data transfer for multiple digital devices. In addition, known UWB transmission and communication methods and systems lack satisfactory quality in areas that can include flexibility, adaptivity and adaptive trade-off capabilities in areas such as power usage, range, and transfer rates, and low cost implementation.

A number of U.S. and non-U.S. patents and patent applications discuss spread spectrum or UWB related systems for various uses, but are nonetheless in accordance with the above described state of the art. The U.S. and non-U.S. patents and patent applications discussed below are hereby incorporated herein by reference in their entirety.

There are several Japanese patents and applications in some of these areas. Japanese patent application JP 11284599, filed on Mar. 31, 1998 and published on Oct. 15, 1999, discusses spread spectrum CDMA mobile communications. Japanese patent application JP 11313005, filed on Apr. 27, 1998 and published on Nov. 9, 1999, discusses a system for rapid carrier synchronization in spread spectrum communication using an intermittently operative signal demodulation circuit. Japanese patent application JP 11027180, filed on Jul. 2, 1997 and published on Jan. 29, 1999, and counterpart European application EP 0889600 discuss a receiving apparatus for use in a mobile communications system, and particularly for use in spread spectrum Code Division Multiple Access communications between a base station and a mobile station. Japanese patent application JP 21378533, filed on Nov. 18, 1988 and published on May 25, 1990, discusses a transmitter for spread spectrum communication.

A number of U.S. patents and published applications discuss spread spectrum or UWB in various contexts. U.S. Pat. No. 6,026,125, issued Feb. 15, 2000 to Larrick, Jr. et al., relates to utilization of a carrier-controlled pulsed UWB signal having a controlled center frequency and an adjustable bandwidth. U.S. Pat. No. 6,351,652, issued Feb. 6, 2002 to Finn et al., discusses impulse UWB communication. U.S. Pat. No. 6,031,862, issued Feb. 29, 2000 to Fullerton et al., and related patents including U.S. Pat. Nos. 5,677,927, 5,960,031, 5,963,581, and 5,995,534, discuss a UWB communications system in which impulse derived signals are multiplied by a template signal, integrated, and then demodulated, to increase the usability if signals which would otherwise be obscured by noise. U.S. Pat. No. 6,075,807, issued Jun. 13, 2000 to Warren et al., relates to a spread spectrum digital matched filter. U.S. Pat. No. 5,177,767, issued Jan. 5, 1993 to Kato, discusses a “structurally simple” wireless spread spectrum transmitting or receiving apparatus which is described as eliminating the need for code synchronization. U.S. Pat. No. 6,002,707, issued Dec. 14, 1999 to Thue, relates to radar system using a wide frequency spectrum signal for radar transmission to eliminate the need for very high energy narrow pulse transmitter and receiver systems. U.S. Pat. No. 5,347,537, issued Jun. 21, 1994 to Mori, et al., and related patents including U.S. Pat. Nos. 5,323,419 and 5,218,620, discuss a direct sequence spread spectrum transmitter and receiver system. U.S. Pat. No. 5,206,881, issued Apr. 27, 1993, discusses a spread spectrum communication system attempting to use rapid synchronization of pseudonoise code signals with data packet signals.

A number of published PCT international applications also discuss spread spectrum or UWB in various contexts. PCT international application, publication number WO 01/39451 published on May 31, 2001, discusses a waveform adaptive transmitter for use in radar or communications applications. PCT international application, publication number WO 01/93441, published on Dec. 6, 2001, discusses a UWB high-speed digital communication system using wavelets or impulses. PCT international application, publication number WO 01/99300, published on Dec. 27, 2001, discusses wireless communications using UWB signaling. PCT international application, publication number WO 01/11814, published on Feb. 15, 2001, discusses a transmission method for broadband wired or wireless transmission of information using spread spectrum technology.

In accordance with all of the above, there is a need in the art for an improved communication methods and systems. Additionally, there is a need in the art for methods and systems to provide wireless connectivity between multiple digital devices in a local environment.

### SUMMARY OF THE INVENTION

The present invention provides communication methods and systems. In some embodiments, the invention provides a method for transmitting information, including transmitting information as a series of burst symbol cycles. Each burst symbol cycle includes an ON period during which one or more symbols are transmitted, each symbol being a bit sequence, each bit sequence mapping to one or more bits of the information, and an OFF period during which no information is transmitted. Bits of the information are mapped to symbols before the symbols are transmitted.

In another embodiment, the invention provides a method for receiving information, including receiving a continuous series of burst symbol cycles. Each burst symbol cycle includes an ON period during which one or more symbols are received, each symbol being a bit sequence, each bit sequence mapping to one or more bits of the information, and an OFF period during which no information is received. Symbols are mapped to bits of the information after the symbols are received.

In another embodiment, the invention provides a method for transmitting information, including translating a continuous signal stream into a series of burst symbol cycles. Each burst symbol cycle includes an ON period during which one or more bits of information is transmitted, and an OFF period during which no information is transmitted.

In other embodiments, the invention provides a method for transmitting information, including translating a narrowband signal into a wider band signal in which blocks of information from the narrowband signal are transmitted at a faster rate in the wider band signal than a transmission rate of the information in the narrowband signal. In one embodiment, blocks of information are transmitted in the wider band signal using a series of burst symbol cycles.

In other embodiments, the invention provides a method for transmitting information, including translating a narrowband signal into a wideband signal including a series of burst symbol cycles. Each burst symbol cycle includes an ON period during which one or more bits of information is transmitted, and an OFF period during which no information is transmitted. The wideband signal can be either carrier based or non-carrier based.

In another embodiment, the invention provides a method for transmitting information, including translating a continuous signal stream into a series of burst symbol cycles. Each burst symbol cycle includes an ON period during which one or more symbols are transmitted, each symbol being a bit sequence, each bit sequence mapping to one or more bits of the information, and an OFF period during which no information is transmitted.

In some embodiments, the invention provides a method for wirelessly transmitting information, including transmitting information as a series of burst symbol cycles. Each burst symbol cycle includes an ON period during which one or more symbols are transmitted, each symbol being a bit sequence, each bit sequence mapping to one or more bits of the information, and an OFF period during which no information is transmitted. Bits of the information are mapped to symbols before the symbols are transmitted.

In another embodiment, the invention provides a method for wirelessly receiving information, including receiving a continuous series of burst symbol cycles. Each burst symbol cycle includes an ON period during which one or more symbols are received, each symbol being a bit sequence, each bit sequence mapping to one or more bits of the information, and an OFF period during which no information is received. Symbols are mapped to bits of the information after the symbols are received.

In another embodiment, the invention provides a method for wirelessly transmitting information, including translating a continuous signal stream into a series of burst symbol cycles. Each burst symbol cycle includes an ON period during which one or more bits of information is transmitted, and an OFF period during which no information is transmitted. In another embodiment, the invention provides a method for wirelessly transmitting information, including translating a continuous signal stream into a series of burst symbol cycles. Each burst symbol cycle includes an ON period during which one or more symbols are transmitted, each symbol being a bit sequence, each bit sequence mapping to one or more bits of the information, and an OFF period during which no information is transmitted.

In another embodiment, the invention provides a wideband based method for wirelessly transmitting information, including transmitting information as a series of burst symbol cycles. Each burst symbol cycle includes an ON period during which one or more symbols are transmitted, each symbol being a chip sequence, each chip sequence mapping to one or more bits of the information, and an OFF period during which no information is transmitted. Bits of the information are mapped to symbols before the symbols are transmitted.

In another embodiment, the invention provides a wideband based method for wirelessly receiving information, including receiving a continuous series of burst symbol cycles. Each burst symbol cycle includes an ON period during which one or more symbols are received, each symbol being a chip sequence, each chip sequence mapping to one or more bits of the information, and an OFF period during which no information is received. Symbols are mapped to bits of the information after the symbols are received.

In another embodiment, the invention provides a UWB based method for transmitting information, including transmitting information as a series of burst symbol cycles. Each burst symbol cycle includes an ON period during which one or more symbols are transmitted, each symbol being a chip sequence, each chip sequence mapping to one or more bits of the information, and an OFF period during which no information is transmitted. Bits of the information are mapped to symbols before the symbols are transmitted.

In another embodiment, the invention provides a UWB based method for receiving information, including receiving a continuous series of burst symbol cycles. Each burst symbol cycle includes an ON period during which one or more symbols are received, each symbol being a chip sequence, each chip sequence mapping to one or more bits of the information, and an OFF period during which no information is received. Symbols are mapped to bits of the information after the symbols are received.

In some embodiments, the invention provides methods for UWB based communication in which information is transmitted utilizing a continuous series of burst symbol cycles, each burst symbol cycle including an ON period during which a number of chips representing a bit of information are transmitted using an ultra-wide band signal, and an OFF period during which no signal is transmitted.

In some embodiments, the methods and systems utilize direct sequence spread spectrum (DSSS) transmission techniques to transmit the signal during the ON periods, and, in some embodiments, binary phase shift keying (BPSK) techniques are utilized to modulate a carrier signal to carry the information. In some embodiments, a duration of each ON and OFF period is varied to provide optimal performance based on variable parameters, such as range, transfer rate, or maximum power usage rate limitations or requirements.

In some embodiments, the methods and systems provide advantages that can include high data transfer rate capability, low power usage, security, low interference susceptibility, low cost implementation, flexibility, scalability, adaptability, and adaptive trade-off capabilities relating to parameters such as power usage, range, and transfer rates.

In some embodiments, the invention provides a system for UWB based, high data transfer rate wireless communication between digital devices, such as, for example, digital devices within a local area such as a home, a building or several buildings, and the system utilizing burst symbol cycle transmission techniques or modulation techniques as described above, or both. In some embodiments, the system further provides the advantages of modularity, auto-configuration, usability in various network topologies, and usability in a wide range of entertainment and computing applications that can require high data transfer rates.

In some embodiments, the techniques of the invention can be used effectively to facilitate communication between a network or group of many users (or communicating devices), and including many cells of users. For example, embodiments of the invention including the use of time division multiplexing (TDM) can be used to facilitate synchronous and asynchronous communication between users or devices in a single cell. Additionally, in applications including communication between users or devices in different cells, some embodiments of the invention include the use of orthogonal or semi-orthogonal sequences to differentiate between users in different cells. Multiple user or multiple device embodiments of the invention, as described herein, generally can include multiple user and device embodiments.

In one embodiment, the invention provides an ultra-wide band based wireless communication method. The method includes, utilizing a transmitter, wirelessly transmitting the information. The method further includes, utilizing a receiver, receiving the transmitted information. Transmitting the information includes utilizing a series of burst symbol cycles, each burst symbol cycle including an ON period during which a plurality of chips are transmitted using anultra-wide band signal, the plurality of chips being utilized to represent a bit of information, and an OFF period during which no signal is transmitted.

In another embodiment, the invention provides an ultra-wide band based wireless communication system. The system includes a transmitter for wirelessly transmitting the information. The system further includes a receiver for receiving the transmitted information. The transmitter transmits the information utilizing a series of burst symbol cycles, each burst symbol cycle including an ON period during which a plurality of chips are transmitted using an ultra-wide band signal, the plurality of chips being utilized to represent a bit of information, and an OFF period during which no signal is transmitted.

In another embodiment, the invention provides an ultra-wide band based wireless communication apparatus. The apparatus includes a transmitter for wirelessly transmitting the information. The apparatus further includes a receiver for receiving the transmitted information. The transmitter transmits the information utilizing a series of burst symbol cycles, each burst symbol cycle including an ON period during which a plurality of chips are transmitted using an ultra-wide band signal, the plurality of chips being utilized to represent a bit of information, and an OFF period during which no signal is transmitted.

In another embodiment, the invention provides a system for ultra-wide band based wireless communication between digital devices. The system includes a first digital device comprising a transmitter and a receiver, and a second digital device including a transmitter and a receiver, in which the transmitters and the receivers of the digital devices are for facilitating wireless communication between the devices. The transmitters are for wirelessly transmitting information, and the receivers are for wirelessly receiving the transmitted information. The transmitters transmit the information utilizing a series of burst symbol cycles, each burst symbol cycle including an ON period during which a plurality of chips are transmitted using an ultra-wide band signal, the plurality of chips being utilized to represent a bit of information, and an OFF period during which no signal is transmitted.

In another embodiment, the invention provides an ultra-wide band based wireless communication method. The method includes, utilizing a transmitter, wirelessly transmitting the information. The method further includes, utilizing a receiver, receiving the transmitted information. Transmitting the information includes utilizing a series of burst symbol cycles, each burst symbol cycle including an ON period during which a plurality of bits are transmitted using an ultra-wide band signal, the plurality of bits being utilized to represent a bit of information, and an OFF period during which no signal is transmitted.

In another embodiment, the invention provides a method for transmitting information, including transmitting, for a first period of time of each of a series of burst symbol cycles, one or more symbols, in which each of the symbols includes a bit sequence, and in which each of the bit sequences maps to one or more bits of the information. The method further includes suspending transmission for a second period of time of each of the series of burst symbol cycles.

In another embodiment, the invention provides a method for receiving information, including receiving, for a first period of time of each of a series of burst symbol cycles, one or more symbols, in which each of the symbols includes a bit sequence, and in which each of the bit sequences maps to one or more bits of the information. The method further includes suspending reception for a second period of time of each of the series of burst symbol cycles.

In another embodiment, the invention provides a method for transmitting information, including translating a continuous signal into a series of burst symbol cycles. The method further includes transmitting, for a first period of time of each of the series of burst symbol cycles, one or more symbols, in which each of the symbols includes a bit sequence, and in which each of the bit sequences maps to one or more bits of the information. The method further includes suspending transmission for a second period of time of each of the series of burst symbol cycles.

In another embodiment, the invention provides a method for transmitting information, including translating a narrowband signal containing the information into a second signal containing the information, the second signal being a wider band signal than the narrowband signal. The method further includes transmitting, for a first period of time of each of a series of cycles, one or more bits of the information at a faster rate than a rate at which the one or more bits information would be transmitted if the one or more bits of information were transmitted using the narrowband signal.

In another embodiment, the invention provides a method for transmitting information, including translating a continuous signal containing the information into a second signal containing the information, the second signal including a series of burst signal cycles. The method further includes transmitting, for a first period of time of each of the series of burst symbol cycles, one or more symbols, each symbol including a bit sequence, in which each of the bit sequences maps to one or more bits of the information. The method further includes suspending transmission for a second period of time of each of the series of burst symbol cycles.

In another embodiment, the invention provides a method for transmitting information, including transmitting, using an ultra-wide band signal, for a first period of time of each of a series of burst symbol cycles, a plurality of chips. The method further includes suspending transmission for a second period of time of each of the series of burst symbol cycles.

In another embodiment, the invention provides an ultra-wide band based wireless communication system, the system including a transmitter for transmitting, using an ultra-wide band signal, for a first period of time of each of a series of burst symbol cycles, one or more symbols, in which each of the symbols includes a bit sequence, and in which each of the bit sequences maps to one or more bits of the information. The transmitter is further for suspending transmission for a second period of time of each of the series of burst symbol cycles. The system further includes a receiver for receiving the transmitted symbols.

In another embodiment, the invention provides an ultra-wide band based wireless communication system, the system including a transmitter for transmitting, using an ultra-wide band signal, for a first period of time of each of a series of burst symbol cycles, a plurality of chips. The transmitter is further for suspending transmission for a second period of time of each of the series of burst symbol cycles. The system further includes a receiver for receiving the transmitted chips.

In another embodiment, the invention provides an ultra-wide band based wireless communication apparatus, including a transmitter for transmitting, using an ultra-wide band signal, for a first period of time of each of a series of burst symbol cycles, a plurality of chips. The transmitter is further for suspending transmission for a second period of time of each of the series of burst symbol cycles. The apparatus further includes a receiver for receiving the transmitted chips.

In another embodiment, the invention provides a system for ultra-wide band based communication between digital devices, including a first digital device including a first transmitter and a first receiver. The system further includes a second digital device including a second transmitter and a second receiver. The first and the second transmitters and the first and the second receivers facilitate communication between the first and the second digital devices. The first and the second transmitters are for transmitting, using an ultra-wide band signal, for a first period of time of each of a series of burst symbol cycles, a plurality of chips. The first and the second transmitters are further for suspending transmission for a second period of time of each of the series of burst symbol cycles. The system further includes a receiver for receiving the transmitted chips.

In another embodiment, the invention provides a method for transmitting information, including means for transmitting, for a first period of time of each of a series of burst symbol cycles, one or more symbols, in which each of the symbols includes a bit sequence, and in which each of the bit sequences maps to one or more bits of the information. The method further includes means for suspending transmission for a second period of time of each of the series of burst symbol cycles.

Additional aspects of the present invention will be apparent in view of the description which follows.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a timing diagram that depicts characteristics of a prior art direct sequence spread spectrum transmission technique;

FIG. 2 is a timing diagram that depicts characteristics of a prior art pulse position modulation spread spectrum transmission technique;

FIG. 3 is a timing diagram that depicts characteristics of a burst symbol cycle based transmission, according to one embodiment of the invention;

FIG. 4 is a block diagram that depicts a system that utilizes burst symbol cycle transmission and reception, according to one embodiment of the invention;

FIG. 5 is a block diagram that depicts a system that utilizes burst symbol cycle bit cycle transmission and reception between two digital devices, according to one embodiment of the invention;

FIG. 6 is a block diagram that depicts a wireless Local area network (LAN) implemented utilizing a gateway server and connecting multiple digital devices, according to one embodiment of the invention;

FIG. 7 is a block diagram depicting an implementation of a transmitter that can transmit burst symbol cycles, according to one embodiment of the invention;

FIG. 8 is a block diagram depicting a shift register based implementation of parallel loading for generating burst symbol cycles, which can be utilized in the transmitter depicted in FIG. 7, according to one embodiment of the invention;

FIG. 9 is a block diagram depicting a multiplexer based implementation of parallel loading for generating burst symbol cycles, which can be utilized in the transmitter depicted in FIG. 7, according to one embodiment of the invention;

FIG. 10 is a block diagram of an implementation of a receiver that can receive burst symbol cycles transmissions, according to one embodiment of the invention;

FIG. 11 is a timing diagram that depicts characteristics of a burst symbol cycle reception, according to one embodiment of the invention; FIG. 12 is a state diagram depicting states associated with signal acquisition and tracking by a receiver, according to one embodiment of the invention;

FIG. 13 is a conceptual diagram graphically depicting I²+Q² correlation as performed at state 3 1206 of FIG. 12, according to one embodiment of the invention;

FIG. 14 is a timing diagram that depicts characteristics of packet transmission with non-burst symbol cycle preamble transmission, according to one embodiment of the invention;

FIG. 15 is a flow diagram depicting a method of transmission, according to one embodiment of the invention;

FIG. 16 is a flow diagram depicting a method of reception, according to one embodiment of the invention;

FIG. 17 is a flow diagram depicting a method of burst symbol cycle signal acquisition and tracking by a receiver, according to one embodiment of the invention;

FIG. 17A is a graph depicting a spectrum of a signal in which each burst is transmitted using a different frequency;

FIG. 18 is a block diagram depicting an implementation of a transceiver, according to one embodiment of the invention;

FIG. 19 is a schematic diagram depicting an implementation of a transceiver, according to one embodiment of the invention;

FIG. 20 is a schematic diagram depicting another implementation of a transceiver, according to another embodiment of the invention;

FIG. 21 is a block diagram that depicts a home gateway server connected to multiple digital devices, according to one embodiment of the invention;

FIG. 22 is a block diagram that depicts an audio/video server connected to multiple audio/video digital devices, according to one embodiment of the invention;

FIG. 23 is a block diagram that depicts multiple digital devices, each connected to a projector, according to one embodiment of the invention;

FIG. 24 is a block diagram that depicts a DVD player connected to multiple television sets, according to one embodiment of the invention;

FIG. 25 is a block diagram that depicts a diagram of an in-building wireless network topology, according to one embodiment of the invention; and,

FIG. 26 is a block diagram that depicts a network including a home gateway and multiple digital devices within a house, according to one embodiment of the invention.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

Appendix 1, attached hereto, is a part of the disclosure and specification of the present application. Appendix 1 generally describes some embodiments of the invention that can be used for high bit rate applications.

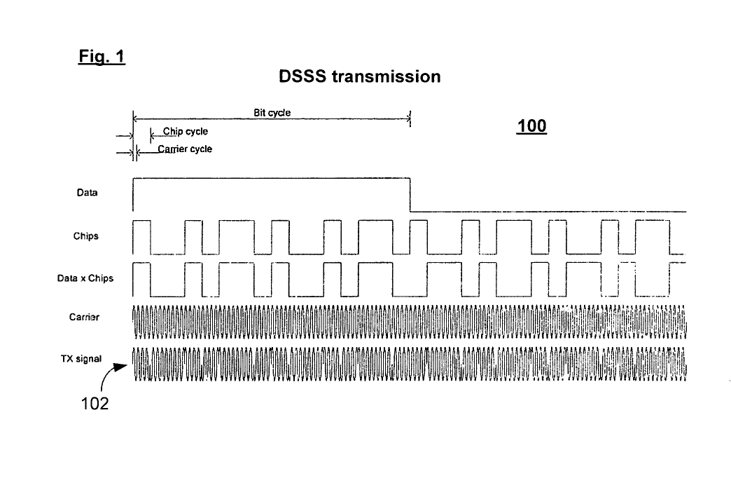

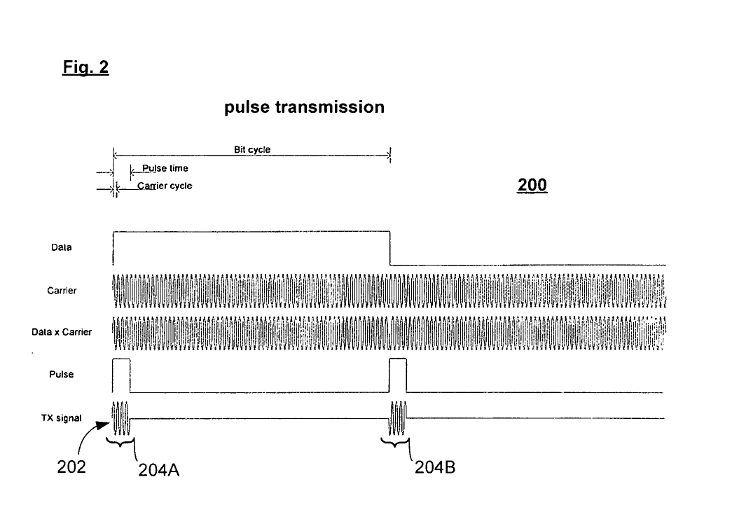

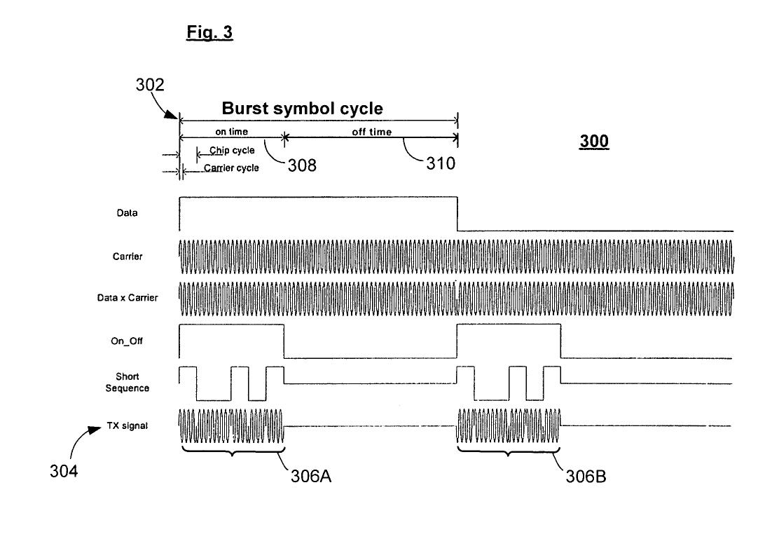

FIGS. 1 and 2 are timing diagrams that depict examples of existing transmission techniques that can be used in spread spectrum techniques. Specifically, FIG. 1 is a timing diagram that depicts characteristics 100 of an existing direct sequence spread spectrum (DSSS) transmission technique utilizing a binary phase shift keying modulation technique, and FIG. 2 is a timing diagram that depicts characteristics 200 of an existing pulse position transmission technique.

In FIG. 1, as shown by the transmitted signal, or TX signal 102, the DSSS transmission techniques utilize continuous transmission of BPSK modulated signal. As with spread spectrum systems generally, each bit of information is represented by a number of transmitted chips. It is to be noted that, in the usual computer parlance, a bit is the smallest unit of information, and a binary bit is usually represented as a “0” or a “1”. In this usual computer parlance, a chip is in fact a bit. Typically in spread spectrum system parlance, however, the term “bit” is utilized to mean a bit of information before spreading, and the term “chip” is typically utilized to mean a bit of information after spreading, which is utilized in combination with other chips to represent a single bit of information existing prior to spreading.

FIG. 2 depicts characteristics 200 of a prior art pulse transmission, including transmitted signal, or TX signal 202. As depicted in transmitted signal 202, the signal consists of intermittent pulses 204A, 204B, each of the pulses 204A, 204B being used to transmit one or more bits of information (the term “bit” as used in this paragraph having a meaning in accordance with typical computer parlance, meaning any smallest unit of information). Pulse transmission techniques, in which intermittent single bits are transmitted, can be used in spread spectrum as well as non-spread spectrum techniques, and with modulation techniques such as pulse amplitude modulation, pulse position modulation (PPM), or other pulse timing based modulation.

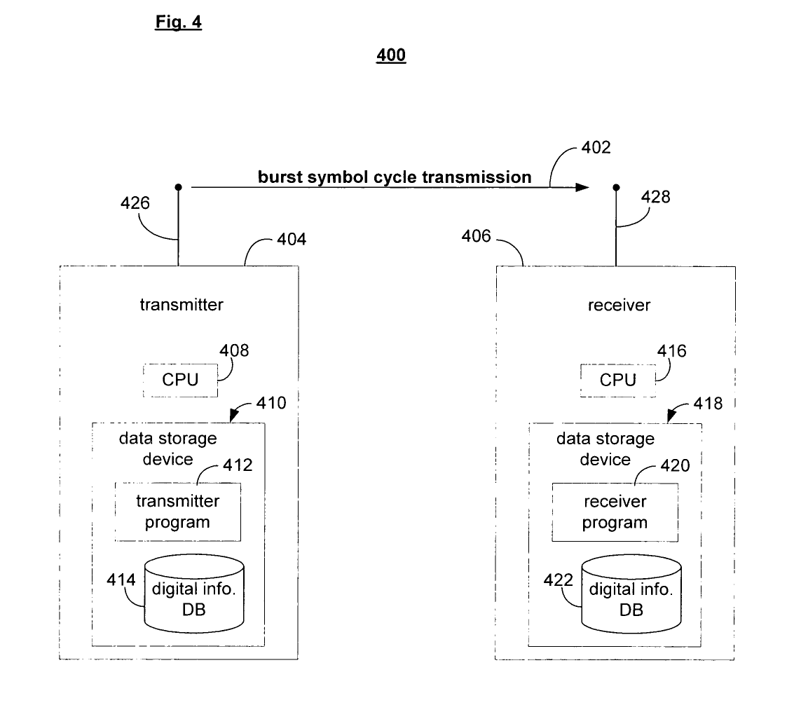

FIG. 3 is a timing diagram that depicts characteristics 300 of a burst symbol cycle based transmission 304, according to one embodiment of the invention. A burst symbol cycle based transmission 304 is depicted. Each burst symbol cycle includes an ON period during which a number of chips representing a bit of information are transmitted using an ultra-wide band signal, and an OFF period during which no signal is transmitted. In this embodiment, each burst symbol cycle is used to transmit a number of chips which represent a bit. As depicted, burst symbol cycle 302 includes ON period 308 followed by OFF period 310. As depicted, each ON period transmission 306A, 306B contains a number of consecutive, uninterrupted transmitted chips 306. In the embodiment depicted, binary phase shift keying (BPSK) is used to modulate the transmitted signal 304 to carry the chips. In other embodiments of the invention, however, many other forms of modulation can be utilized, including other phase modulation techniques such as quaternary phase shift keying (QPSK), position based modulation, combinations of phase and position based modulation, and various other modulation techniques, including various modulation techniques typically associated with narrow band transmission systems. For example, in some embodiments, narrowband signals are translated into a series of burst symbol cycles and can be transformed into a UWB signal, which techniques can include multiplication of the narrowband signal by a wideband burst symbol cycle signal (which can be either a carrier based or non-carrier based signal, as further described in Appendix C of previously incorporated by reference U.S. Provisional Patent Application No. 60/404,070), or even a general wavelet.

In some embodiments of the invention, information to be transmitted is translated into a symbol, the symbol being a sequence of bits that maps to, or is used to represent, one or more bits of information to be transmitted. The bit sequence is generally different than the one or more bits of information, but, in some embodiments, can be identical. In addition, in some embodiments, in which the bit sequence is identical to the one or more bits of information to be transmitted, mapping can be unnecessary (both on a transmitting and receiving end), and therefore not included. As such, in some embodiments, the term “symbol” can simply include signals or bits of information to be transmitted or received.

Generally, however, bits of information are mapped to one or more symbols, and the symbols are transmitted during an ON period. On a receiving end, the one or more symbols are received during an ON period, and then mapped, or decoded, to the one or more bits of information the symbols are used to represent. Although generally a symbol maps to one or more bits of information, it is to be noted that, in some embodiments of the invention, more than one symbol or burst can be used to represent a single bit of information.

In some embodiments, the bit sequences of the symbols can be chosen or varied to control or create trade-offs between system parameters. For example, peak to average power ratio and spectral shaping or widening can be controlled by such techniques. It is to be noted that, in some embodiments of the invention, sequences do not have to be repeated or constant, but can change between, for example, bits or groups of bits, packets, or cells. It is to be noted, however, that, in some embodiments of the invention, other techniques besides sequencing related techniques can be used to control various system parameters (see, for example, the discussion of embodiments of the invention using orthogonal frequency division multiplexing, or OFDM, appearing in Appendix 1 herein). Furthermore, in some embodiments, each burst can be transmitted using a different frequency or frequency range, or in more than one frequency or frequency range, or in different positions. For example, see the discussion of embodiments of the invention using two-plane transmitting, appearing in Appendix 1 herein.

In addition, in some embodiments of the invention, lengths of ON periods and lengths of OFF periods change from cycle to cycle.

In general, burst symbol cycle transmission, according to various embodiments of the invention, provide greater flexibility and control of system parameters, including bit rates, and duty cycles. For example, pulse transmission generally uses either pulse position modulation or pulse amplitude modulation. The relatively simple pulse transmission techniques do not allow the degree of control over system parameters as do the techniques of the present invention. In addition, various narrowband and spread spectrum techniques also do not allow such control. For example, spread spectrum DSSS techniques generally provide lower peak power than, for example, pulse transmission techniques, but higher overall power consumption. Pulse transmission techniques, conversely, provide lower overall power consumption than DSSS techniques, but higher peak power. In addition, in some embodiments of the invention, spectral shaping is controlled by selecting polarity of signals of an ON period of a burst symbol cycle, which is an advantage over pulse transmission techniques, which have a constant spectral shape that cannot be controlled in the manner just described. In addition, some embodiments of the present invention provide advantageous trade off control capability, in comparison with DSSS techniques and pulse techniques, with respect to other parameters, including, for example, filtering, switching. Various embodiments of the present invention, however, allow trade off and control between such parameters, which degree of control is unavailable in existing techniques.

In some embodiments, a continuous or other non-burst symbol cycle data stream or signal is translated into burst symbol cycles before being transmitted. For example, various narrowband transmissions can be converted into wideband burst symbol cycle signals according to the methods of the present invention. By such techniques, the advantages of transmission and reception according to some embodiments of the present invention can be gained, which advantages would be unavailable if information is transmitted and received by existing narrowband techniques. As described in more detail herein, some embodiments of the invention include translating a narrowband signal into a series of burst symbol cycles by multiplying the continuous signal by a burst symbol cycle signal (which can be either a carrier based or noncarrier based signal, or a as further described in Appendix C of previously incorporated by reference U.S. Provisional Patent Application No. 60/404,070), or even a general wavelet. Such techniques can be used, in some embodiments of the invention, to translate a narrowband signal into a wideband or a UWB signal.

In some embodiments of the invention, blocks of a narrowband signal are transmitted at a faster rate than in the original narrowband signal, thus widening the spectrum of the signal, without multiplication by a wider band signal.

In some embodiments of the invention in which information is transmitted (or received) at a faster rate than in an original narrowband signal, blocks of information can be transmitted (or received) in the form of burst symbol cycles including an ON period during which the information of the block is transmitted, followed by an OFF period to fill the remainder of time that would be required for the block of information to be transmitted in the original narrowband signal. Alternatively, a portion of the remainder of time can be used to transmit signal, such as a repeated block or blocks of information, a different block or blocks of information, a partial block or blocks of information, or a varied form of block or blocks of information, such that the OFF period of each cycle is of shorter duration. Furthermore, in some embodiments, the entire remainder period can be used to transmit signal, such that instead of a series of burst symbol cycles, a continuous signal is transmitted.

It is to be noted that the methods of the invention can be used to advantage in wired as well as wireless systems, including wired UWB systems and implementations. It is to be noted, however, that the methods of the invention include embodiments in which no narrowband or other continuous or non-continuous data stream is converted. It is further to be noted that the invention contemplated embodiments including a carrier signal as well as embodiments that do not include a carrier signal (see Appendix C of previously incorporated by reference U.S. Provisional Patent Application No. 60/404,070 for further discussion and examples of carrier and non-carrier based embodiments of the invention).

It is to be noted that, generally, burst symbol cycle transmission causes a wider spectral band than continuous or other non-burst symbol cycle transmissions. For example, translating narrowband data streams into burst symbol cycles generally causes widening of the spectrum utilized. As such, although the techniques of various embodiments of the invention can be applied and are useful in non-UWB contexts, the techniques are generally especially advantageous when utilized for wireless UWB communication, since, among other things, the techniques generally lend themselves best to very wide band communication systems, and also help widen the used spectral bandwidth.

In the embodiment depicted in FIG. 3, burst symbol cycle transmission is utilized in a spread spectrum context. As used herein, the term, “spread spectrum” is not limited to existing spread spectrum techniques, but rather includes any technique, including new techniques as described herein, in which some or several aspects of spread spectrum methodology is a part. In some embodiments, such as the spread spectrum based embodiment depicted in FIG. 3, power control can be implemented by, for example, changing the number of chips per bit.

To support and enable transmissions to multiple different receiving entities, such as, for example, digital or computerized devices, and different chip polarity patterns and sequence positions can be utilized for identification of certain transmitted information as being intended for a particular receiving entity or entities. Such techniques can be utilized to facilitate communication between many users or devices, including multiple cells of users or devices, each cell containing multiple users or devices. Sequences can be the same for all transmitted bits for an intended receiving entity, or can change every bit. Sequences that can be so utilized include, for example, pseudonoise (PN) sequences, Barker sequences, Gold sequences, Kasami sequences, or others.

UWB transmission systems have various uses. UWB transmission systems are typically within the 0 MHz to 5 GHz band, typically cover a large spectrum of above 20% of the center frequency, and typically radiate a power of approximately 1 mW. UWB systems have in the past been used by for radar and radar-like applications, allowing penetration of thick obstacles such as building walls. UWB is also known to provide high resistance against detection and interception, high multipath immunity, high throughput, and precision ranging and localization. Decreased restriction on the use of UWB is expected in the near future.

The present invention provides UWB based communication methods and systems. In some embodiments, the invention provides methods for UWB based communication in which information is transmitted as described with reference to FIG. 3, utilizing a continuous series of burst symbol cycles, each burst symbol cycle including an ON period during which a number of chips representing a bit of information are transmitted using an ultra-wide band signal, and an OFF period during which no signal is transmitted. In some embodiments, narrowband signals are translated into a series of wider band or wide band burst symbol cycles, or are transformed into a UWB signal, and techniques used can include multiplication of the narrowband signal by a burst symbol cycle signal (which can be either a carrier based or non-carrier based signal, or a as further described in Appendix C of previously incorporated by reference U.S. Provisional Patent Application No. 60/404,070), or even a general wavelet. In some embodiments, a duration of each ON and OFF period is varied, such as by using a fast variable ON period, to provide optimal performance based on variable parameters, such as range, transfer rate, or maximum power usage rate limitations or requirements. In some embodiments, the methods and systems provide advantages that can include high data transfer rate capability, low power usage, security, low interference susceptibility, low cost implementation, flexibility, adaptability, and adaptive trade-off capabilities relating to parameters such as power usage, range, and transfer rates.

In some embodiments, the invention provides a system for UWB based, high data transfer rate wireless communication between digital devices, such as, for example, digital devices within a local area such as a home, a building or several buildings, and the system utilizing burst symbol cycle transmission techniques or modulation techniques as described above, or both. In some embodiments, the system further provides the advantages of modularity, auto-configuration, usability in various network topologies, and usability in a wide range of entertainment and computing applications that can require high data transfer rates, including multi-streaming of high quality audio and video, and broadband multimedia applications.

In some embodiments, the physical components, hardware, software, and programs as described herein are implemented utilizing small, low power modular subunits including PHY, MAC, and protocol stack software. In some embodiments, the subunits connect to digital or computerized devices utilizing standard interfaces, such as USB, IEEE 1394, Ethernet, PCMCIA, etc. In some embodiments, auto-configuration is provided, and power can be supplied from standard interfaces. In some embodiments, subunits or other components are mounted on an antenna.

In some embodiments, the methods and systems of the invention are utilized to support a wide range of simultaneously provided wireless services and applications, providing high data transfer rates and a high degree of reliability and quality. For example, supported applications can include high rate distribution of MPEG-2 channels, high quality broadband and multimedia applications. Various low to medium transfer rate applications can also be supported, including bi-directional real-time channels for video or audio calling or conferencing, or interactive gaming, resource file sharing, file transfer, and control information transfer. In some embodiments, 100-500 MB/sec or greater maximum transfer rates can be achieved. In some embodiments, higher or middle rate services can be supported for ranges up to about 15-20 meters, and middle or lower rate services for ranges of about 30-50 meters or more. In some embodiments, the invention supports up to at least three independent cells with overlap in a typical building, and supports non-interfering co-existence with other wireless systems in typical environments and use conditions.

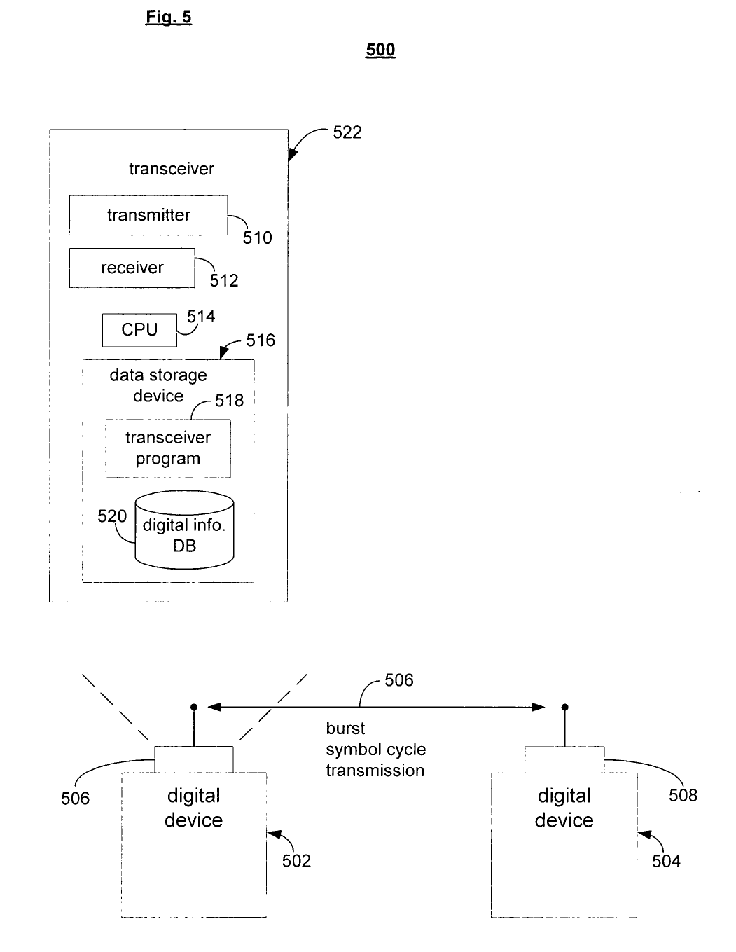

FIGS. 4-6 are block diagrams that illustrate certain implementations and embodiments of the invention. FIG. 4 depicts a system 400 that utilizes burst symbol cycle transmission and reception, according to one embodiment of the invention. Herein, a burst symbol cycle transmission generally includes a transmission including a continuous series of burst symbol cycles. As depicted, a burst symbol cycle transmission 402 is wirelessly transmitted from a transmitter 404 and received by a receiver 406. Herein, wireless transmissions and wireless communications refer to transmissions and communications that are sent wirelessly from a transmitting entity to a receiving entity; the terms generally do not refer to internal workings of transmitters, receivers, and transceivers, which can involve wires.

Herein, the terms transmitter, receiver, and transceiver generally include devices that include any and all necessary components necessary to implement the functions of the device, including physical components, such as one or more antennas, as well as computerized or computer hardware, software, and programming. The transmitter 404 and receiver 406 each include one or more antennas 426, 428 for transmitting and receiving burst symbol cycle transmissions in accordance with the invention. The transmitter 404 and receiver 406 each include one or more central processing units (CPUs) 408, 416, and one or more data storage devices 410, 418. The data storage device of the transmitter 404 includes a digital information database 414 and a transmitter program 412. The data storage device of the receiver 406 includes a digital information database 422 and a receiver program 412. Data storage devices as described herein can include various amounts of RAM for storing computer programs and other data. In addition, transmitters, receivers, and transceivers as described herein can include various other components typically associated with transmitters, receivers, and transceivers. In different embodiments, transmitters, receivers, and transceivers as described herein can include special or limited purpose computers, or can include general purpose computers that generally operate under and execute computer programs under the control of an operating system, such as Windows, Macintosh, UNIX, etc. Furthermore, transceivers, as described herein, generally includes a device having the functionality of a transmitter and a receiver as described herein, and any such device is considered to include a transmitter and receiver, whether or not physical or any computerized or programming components of the transmitter and receiver are separate or indistinguishably intermingled.

The transmitter program 412 and the receiver program 416 each generally include all programming and applications, programming or application modules, etc. necessary to implement transmission and reception of burst symbol cycle transmissions, respectively, in accordance with the methods of the invention as described herein. In some embodiments, the transmitter 404, the receiver 406, or each, can be replaced with a transceiver, combining the functionality of both a transmitter and a receiver.

Generally, the computer programs of the present invention are tangibly embodied in a computer-readable medium, e.g., one or more data storage devices attached to a computer. In some embodiments under the control of an operating system, computer programs may be loaded from data storage devices into computer RAM for subsequent execution by the CPU. The computer programs include instructions which, when read and executed by the computer, cause the computer to perform the steps necessary to execute elements of techniques described herein.

The digital information databases 414, 422 of the transmitter 404 and the receiver 422 generally include any and all stored information utilized in the functions of the transmitter 404 and the receiver 406. For example, the digital information database 414 of the transmitter 404 includes stored information to be transmitted to the receiver, as well as any and all stored intermediate, processed, coded, and decoded information, in accordance with the methods of the invention as described herein. The digital information database 422 of the receiver 406 generally include any and all received information, as well as any and all intermediate, processed, coded, and decoded information, in accordance with the methods of the invention as described herein. While not shown, in some embodiments, the transmitter 404, as well as transceivers described herein, can obtain or receive information to be stored in the digital information database 414 from various sources and in various ways, such as by wired communication, wireless communication, reading of an external storage device such as a floppy disk or compact disk, or in any of various other ways.

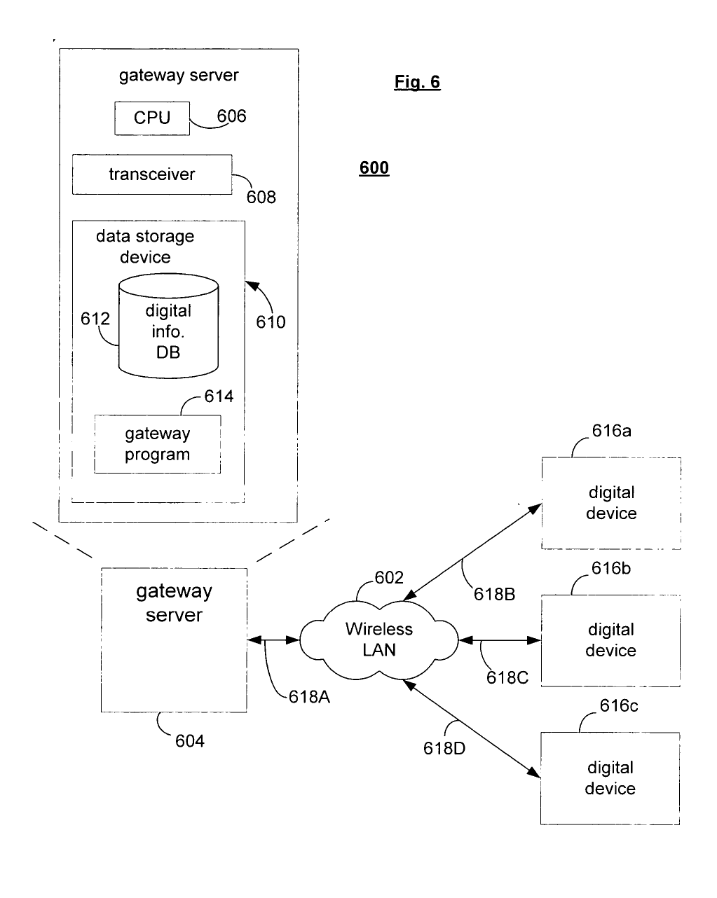

FIG. 5 depicts a system 500 that utilizes burst symbol cycle transmission 506 transmitted by a transmitter 506 of a first digital device 502 and received by a receiver 508 of a second digital device 504. As depicted, the transceiver 522 includes a transmitter 510, a receivers 512, one or more CPUs 514, and one or more data storage devices 516. The data storage device 516 includes a transceiver program and a digital information database 520. It is to be understood that the transceiver 522 generally includes any and all components necessary to allow transmission and reception of burst symbol cycle transmissions in accordance with the invention as described herein. Various different configurations are possible in accordance with the invention. For example, the transmitter 510 and receiver 512 and elements thereof can be separate, as shown, or combined, and CPUs and data storage devices can be included in the transmitter as well as in the receiver, or one or more CPUs, data storage devices, and other elements can be utilized to perform transmitter and receiver functions. As depicted, the data storage device 516 of the transceiver 522 includes transceiver program 518 and digital information database 520, which, alone or in combination with elements of the transmitter 510 and the receiver 512, enable to transceiver to perform burst symbol cycle transmission and reception in accordance with the methods of the invention as described herein.

FIG. 6 depicts a wireless Local area network (LAN) 602 implemented utilizing a gateway server 604 and connecting multiple digital devices 616A, 616B, 616C according to one embodiment of the invention. It is to be noted that, in some embodiments, the invention can be implemented, in a wireless or wired fashion, within or including a personal area network (PAN), or a LAN, or both, or various other types and combinations of networks. The gateway server 604 is a server computer including a CPU 606, a transceiver 608, and a data storage device 610. As depicted, the data storage device includes a digital information database 612 and a home gateway program 614. The gateway server 604 can be an audio/video server or any of various types of servers for various applications. The gateway program 614 generally includes all programming, applications, and programming or application modules necessary to perform the functions of the gateway server 604 as described herein. Specifically, the gateway server 604 is for transmission and reception of burst symbol cycle transmissions as well as management and integration of communication through the wireless LAN 602 to, from, and between the digital devices and the gateway server 604. As depicted, the gateway server 604 coordinates and manages information flow, which can include multiple simultaneous transmissions from transmitting devices intended to be received by one or more particular receiving devices. Arrows 618A, 618B, 618C, and 618D represent burst symbol cycle communications.

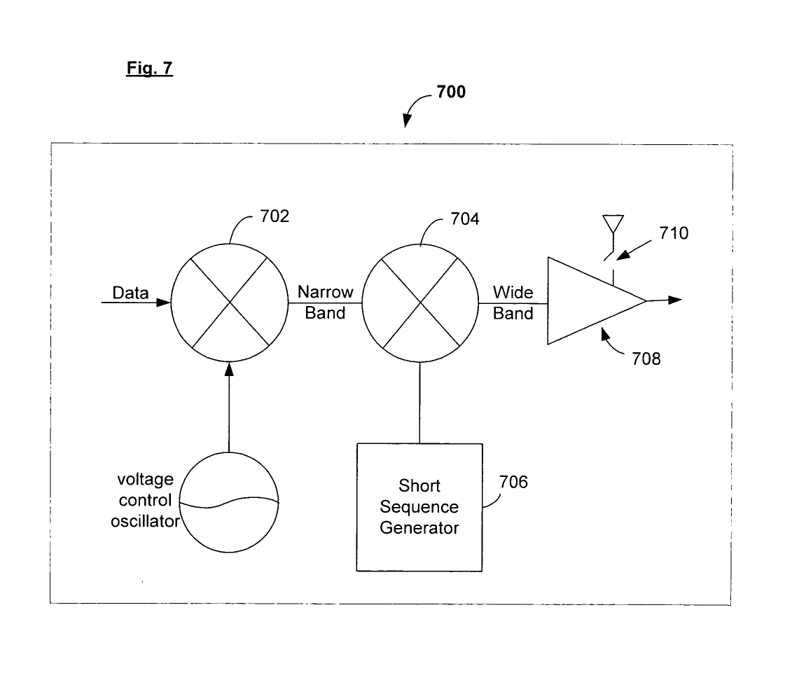

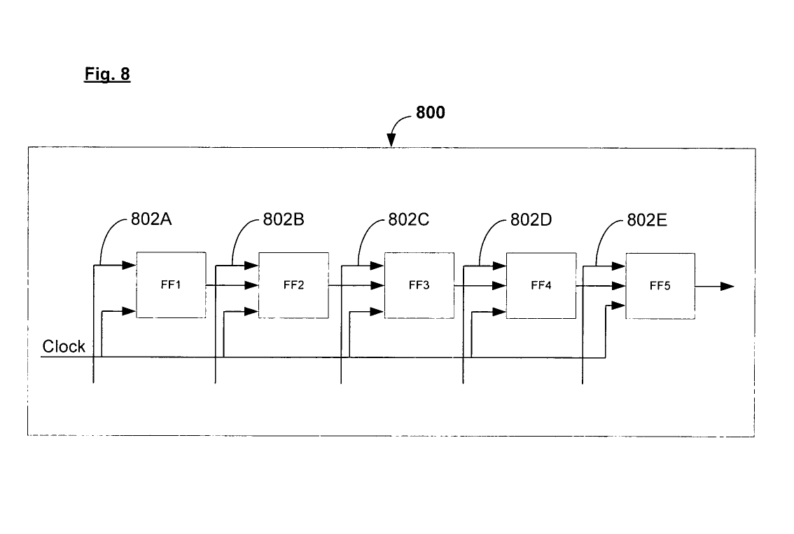

FIG. 7 is a block diagram 700 depicting an implementation of a transmitter that can transmit burst symbol cycles, according to one embodiment of the invention. A first mixer 702 implements a BRSK narrow band system. The second mixer 704 then spreads the signal by mixing it with a fast burst symbol cycle signal from the burst symbol cycle generator 706. A second mixer LO input is used to block signal during OFF periods of burst symbol cycles by timely applying a zero signal from the burst symbol cycle generator 706. Mixers, which are three-port RF components utilized to modify a frequency of an input signal, are commercially available from many companies, such as HD Communications Corp., Ronkonkoma, N.Y. Voltage of amplifier 708 is switched 710 between burst symbol cycles to reduce the transmit power consumption, which is one way in which the methods of the invention can be used to allow low power consumption. Burst symbol cycle generation, such as by the burst symbol cycle generator 706 depicted in FIG. 7, can by implemented in several different ways.

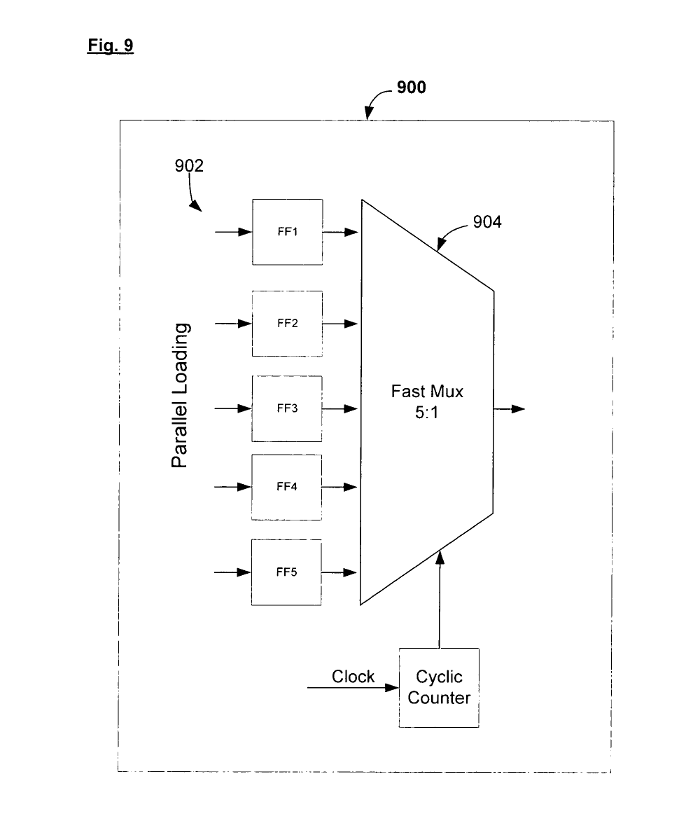

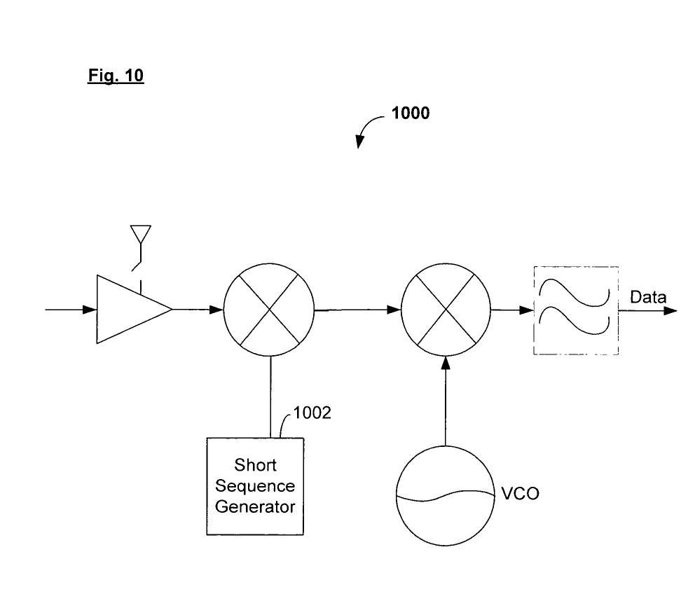

FIGS. 8 and 9 are block diagrams depicted two techniques that can be utilized in generating bursts (of burst symbol cycles). FIG. 8 is a block diagram depicting a shift register based implementation of parallel loading for generating burst symbol cycles, which can be utilized in the transmitter depicted in FIG. 7, according to one embodiment of the invention. In the technique depicted in FIG. 8, burst symbol cycles are generated utilizing slow parallel loading 802A, 802B, 802C, 802D, 802E and fast release. For example, assuming a ON period including five chips, each of the five chips can be loaded in parallel into the register, and a system clock is used to serially expel the chips.

FIG. 9 is a block diagram depicting a multiplexer based implementation of parallel loading for generating bursts, which can be utilized in the transmitter depicted in FIG. 7, according to one embodiment of the invention. The technique depicted in FIG. 9 utilizes slow parallel loading 902 and multiplexing utilizing a fast multiplexer 904. For example, in a multiplexer based implementation, loading of five chips, for example, can be accomplished identically to that described in the embodiment depicted in FIG. 8. In the embodiments depicted in FIG. 9, however, a counter can cycle from one to five and control the multiplexer 904, and the multiplexer can expel the chips serially.

In addition to the methods described above for generating bursts, in some embodiments, ternary modulation can be used (see, for example, the carrierless implementation described in Appendix C of previously incorporated by reference U.S. Provisional Patent Application No. 60/404,070).

FIG. 10 is a block diagram 1000 of an implementation of a receiver that can receive burst symbol cycle transmissions, according to one embodiment of the invention. As depicted in FIG. 10, the receiver is implemented utilizing correlation of a received, or input, signal with an unmodulated version of the input burst symbol cycle. As depicted, correlation is implemented by multiplying the received signal with the unmodulated burst symbol cycle generated by a burst symbol cycle generator 1002 followed by matched filtering to the sequence length. For example, in some embodiments, a filtering and sampling technique can be used, in which, after multiplying a carrier and a short sequence, a low pass filter can be used based on the ON period where a signal is being sampled in a maximal energy state (See FIG. 11). Alternatively, an “integrated and dump,” or I & D, technique can be used.

In any of the embodiments depicted in FIGS. 8-10, a switch can be used as an initial component to block out noise during OFF periods.

FIG. 11 is a timing diagram that depicts characteristics of a burst symbol cycle reception, according to one embodiment of the invention. Specifically, FIG. 11 depicts transmitted, or TX, signals and received, or RX, signals over time while a receiver according to one embodiment of the invention is synchronized with a transmitter burst symbol cycle generator. The allowed sampling time window 1102 begins at the start of an OFF period. It is to be noted that a single base band filter can be utilized to accommodate many different information transfer rates, or bit rates, because the filter is matched to sequence length rather than bit rate. Substantial flexibility is provided in terms of the accuracy of the filter bandwidth because integration in area with no signal or noise, i.e., the OFF period, does not change the output signal to noise ratio. In addition, using a burst symbol cycle allows for AC coupling in the base band with a single and higher cutoff frequency.

FIGS. 12-14 describe signal tracking and acquisition according to some embodiments of the invention. FIGS. 12-14 relate to a packet-based signaling implementation, in which a receiver must acquire and track a signal on a packet-by-packet basis. While FIGS. 12-14 relate to a packet-based signaling implementation, it is to be noted that other embodiments of the invention are contemplated which use non-packet-based signaling implementations.

FIG. 12 is a state diagram depicting states 1200 associated with signal acquisition and tracking by a receiver, according to one embodiment of the invention. State 1 1202 represents a receiver in an idle mode, which can be a power-saving low power mode, waiting for a signal. Upon identification of a signal, the receiver assumes state 2 1204.

The State 2 1204 represents a receiver state in which automatic gain control (AGC) is activated during fast calibration of the received signal, or received signal chain. Upon stabilization of gain, an automatic gain control loop is switched to slow gain control for the remainder of the information packet, and the receiver assumes state 3 1206.

The state 3 1206 represents sequence acquisition, in which the receiver attempts to synchronize on a transmitter sequence phase while searching to detect I²+Q² energy, perform I²+Q² correlation, using a clock swallow mechanism (a known technique used in DSSS systems for acquiring sequence phase in, for example, a DSSS system). While detecting energy, early-late dither (a known technique used, for example, in DSSS systems) is being performed to detect an exact phase in order to detect a burst symbol cycle center using fine step search, or early-late dither, in a burst symbol cycle generator of the receiver. In some embodiments, if acquisition at state 3 1206 is successful, state 4 1208 is assumed; if acquisition is unsuccessful, the state 1 1202 is assumed.

The state 4 1208 represents carrier acquisition, at which the receiver estimates the transmitter carrier phase using In phase and Quadrature (I and Q) signals (phase detection). In some embodiments, if the detection is successful, the receiver assumes state 5 1210; otherwise, the receiver 1200 assumes the state 1 1202.

The state 5 1210 represents phase tracking, at which the receiver is in a tracking mode and utilizes a Costas loop for phase tracking. Costas loop tracking generally includes using two correlators with 90 degree separation between the locals (I and Q), multiplying I and Q, and, after using a loop filter to control the clock, tracking the carrier signal. Because the receiver utilizes a single clock, this tracking also maintains the sequence phase. When the information packet ends, the receiver assumes state 1 1202. It is to be noted that a Costas loop tracking system can also be used in carrierless embodiments of the invention.

In some embodiments, there is no need for resynchronization between bits, i.e., no need for resynchronization between ON periods (after initial synchronization), and tracking is based on receiver VCXO stability. For example, in a reception situation involving 10 MHz bits, a 10 nsec ON period, and a 90 nsec OFF period, the receiver VCXO is sufficiently stable to maintain its frequency and phase over burst symbol cycle durations.

FIG. 13 is conceptual diagram 1300 graphically depicting I²+Q² correlation as performed at state 3 1206 of FIG. 12, according to one embodiment of the invention. In-phase mixer output 1302, quadrature mixer output 1304, and I²+Q² output are depicted.

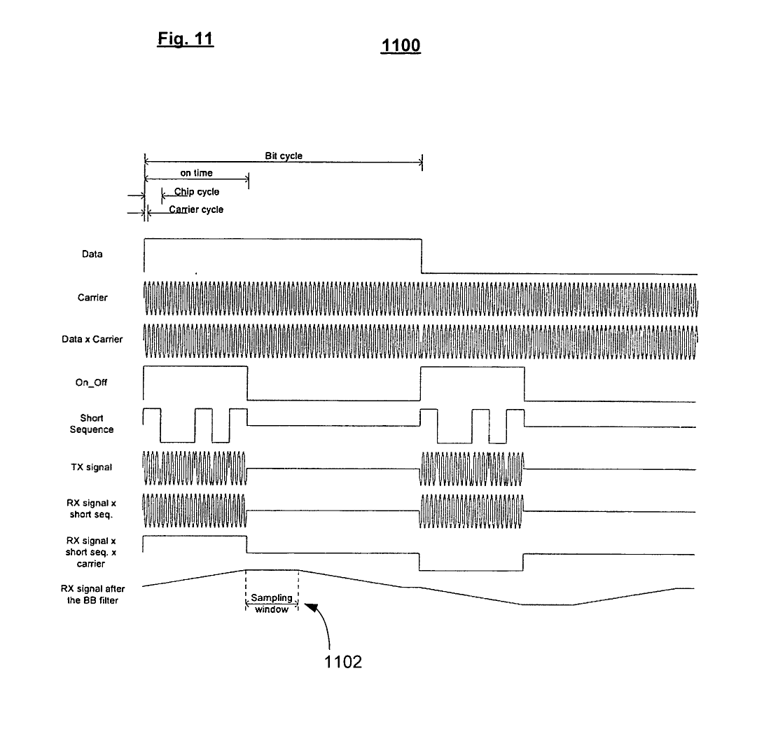

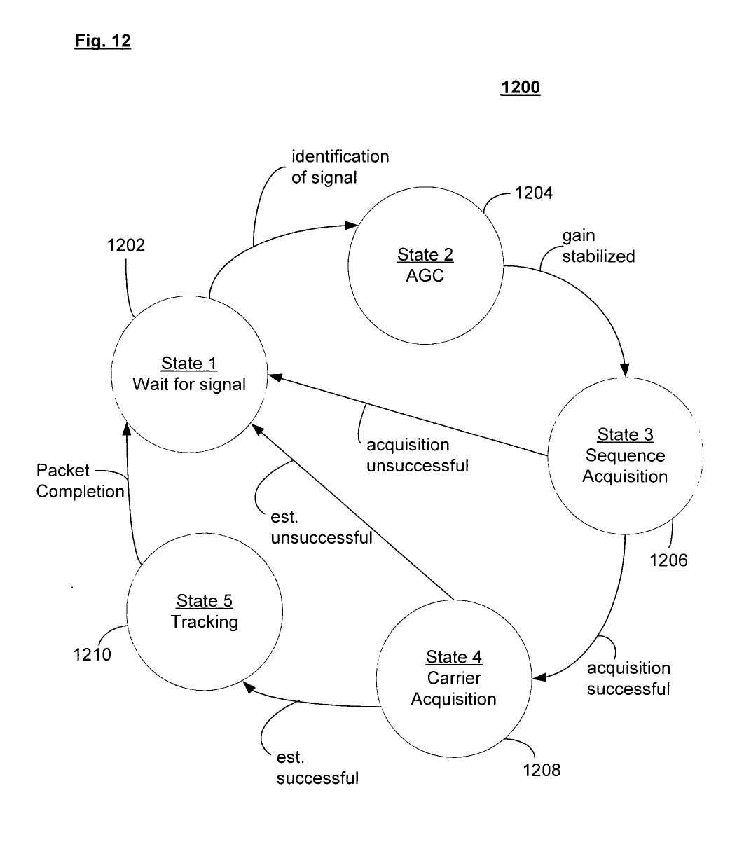

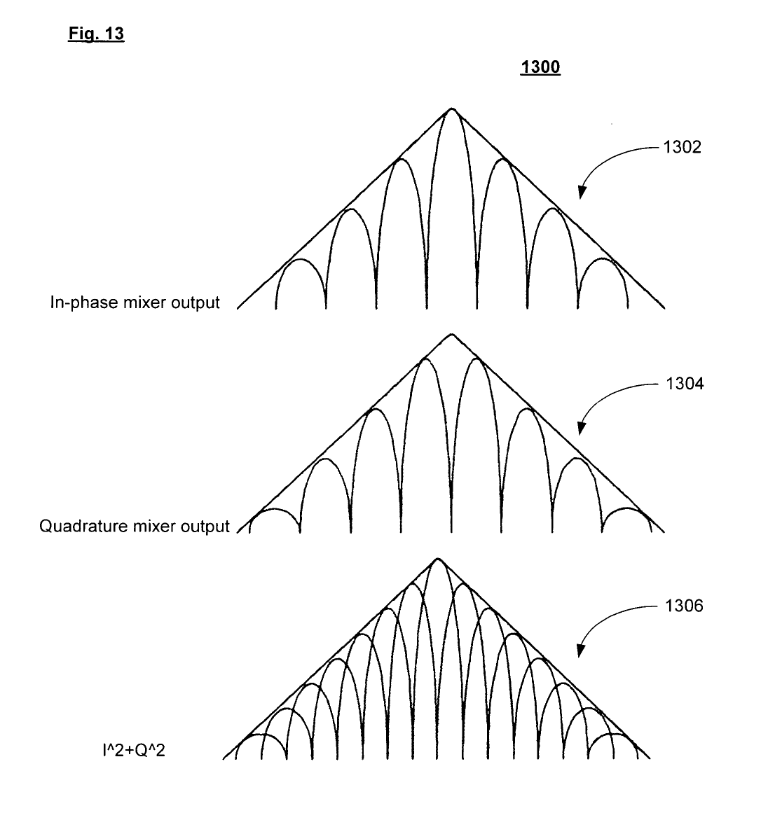

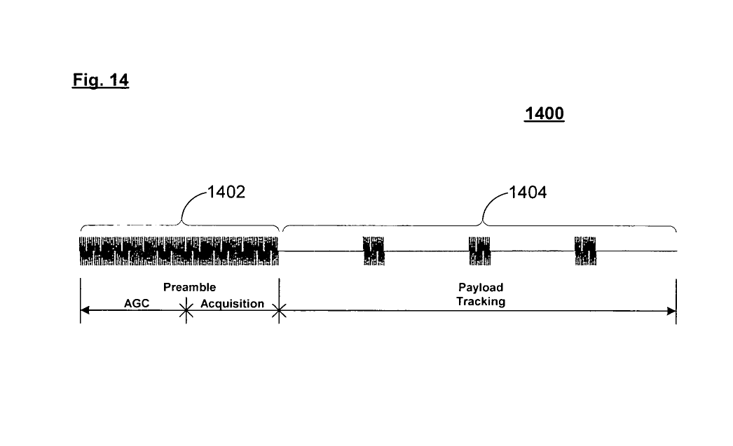

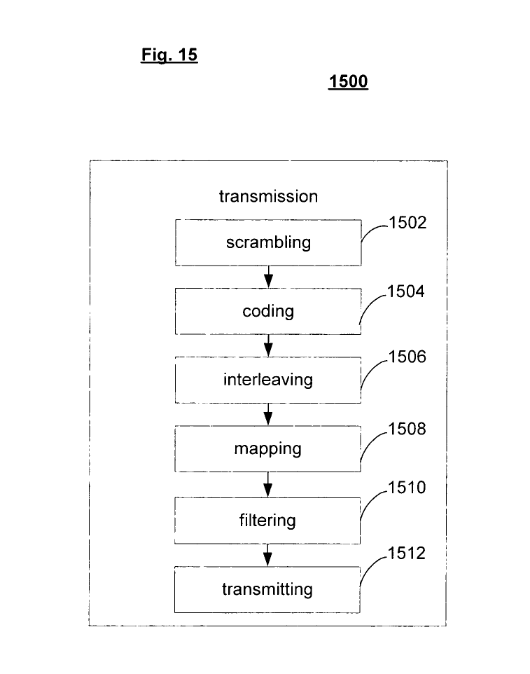

FIG. 14 is a timing diagram that depicts characteristics 1400 of packet transmission with non-burst symbol cycle, continuous preamble transmission, according to one embodiment of the invention. In the embodiment depicted in FIG. 14, for fast synchronization on a new packet of information, in the preamble portion 1402 of each packet, a continuous transmission is utilized. The payload portion 1404, however, is transmitted (and received) as a burst symbol sequence. After the initial synchronization, the OFF periods between ON periods of the burst symbol sequence transmission are sufficiently short that re-synchronization between ON periods is unnecessary, increasing system efficiency.

FIG. 15 is a flow diagram depicting a method 1500 of transmission, according to one embodiment of the invention. At step 1502, signal scrambling is performed to create a “white” source without a DC component. In relatively low bit rate situations, to more sufficiently move the signal away from DC, additional multiplying utilizing a several MHz clock can be performed, such as, for example, Manchester coding (for example, using a “0” signal followed by a “1” signal to code for a positive bit, and a “1” signal followed by a “0” signal to code for a negative bit). At step 1504, coding of the signal is performed, allowing improved interference resistance. At step 1506, interleaving of the signal is performed, which combats burst error. At step 1508, each bit or group of bits is mapped into a sequence of chips, based on the bit value and a burst symbol cycle generator. At step 1510, filtering according to a required mask is performed and the signal is sent to an antenna of a transmitter performing the method 1500. Finally, at step 1512, the signal is transmitted in a burst symbol cycle manner, with ON period/OFF period durations varying with bit rate. For example, in some embodiments, in an instance of single bit mapping to sequence a given bit utilizing a 10 MHz bit rate and a 1 GHz chip rate, burst symbol cycles can be utilized with ON periods during which 20 chips are transmitted and an OFF period of four times that duration.

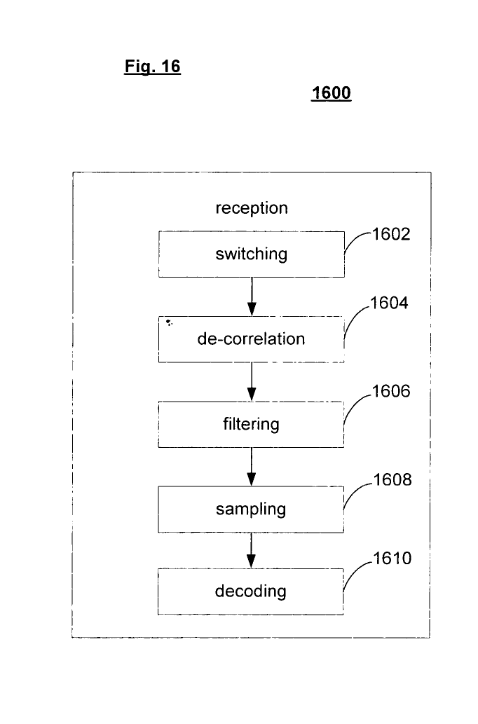

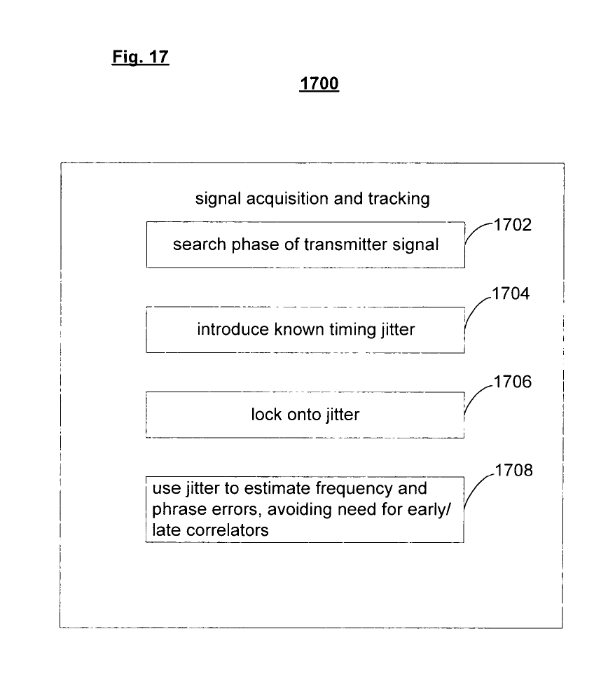

FIG. 16 is a flow diagram depicting a method 1600 of reception, according to one embodiment of the invention. At step 1602, a received signal is switched in accordance with a burst symbol cycle, reducing noise and interference. At step 1604, the signal is de-correlated using a sequence and mapping function corresponding to those utilized by the transmitter that transmitted to received signal. At step 1606, the output signal is filtered using an AC coupled to a low pass filter (note that the presence of OFF periods allows a less accurate filter to be used than would otherwise be required). At step 1608, the output signal from step 1604 is sampled using an A/D. At step 1610, samples are decoded in order to estimate a value for I, which is used in de-interleaving, de-scrambling, and de-coding to obtain information.

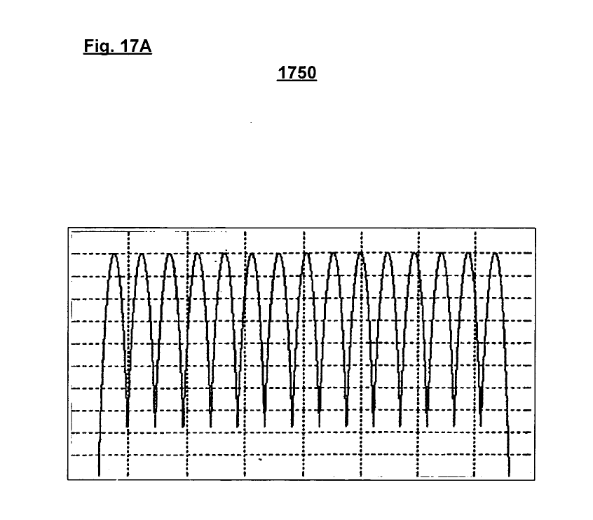

FIG. 17 is a flow diagram depicting a method 1700 of burst symbol cycle signal acquisition and tracking by a receiver, according to one embodiment of the invention. At step 1702, acquisition is performed by searching a phase of a burst symbol cycle generator signal utilized by a transmitter that transmitted the received signal. At step 1704, a known jitter function (sine function) is introduced into a system clock. At step 1706, the receiver locks on to the jitter function. At step 1708, the receiver uses the jitter function to estimate frequency and phase errors, thereby avoiding the need for early/late correlators.

FIG. 17A is a graph 1750 depicting a spectrum of a signal in which each burst is transmitted using a different frequency. In some embodiments of the invention, each burst is transmitted in a different frequency. Furthermore, in some embodiments, each burst is transmitted in more than one frequency. Additionally, in some embodiments, the frequency or frequencies can be selected according to information to be transmitted, a pseudo-random sequence, or both.

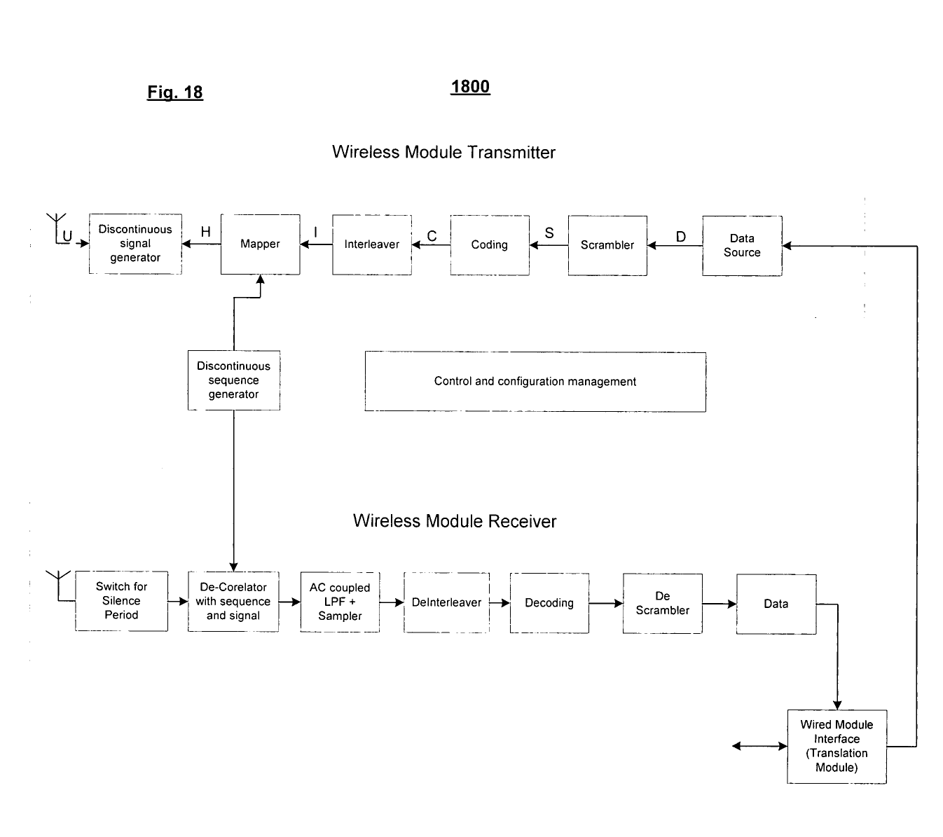

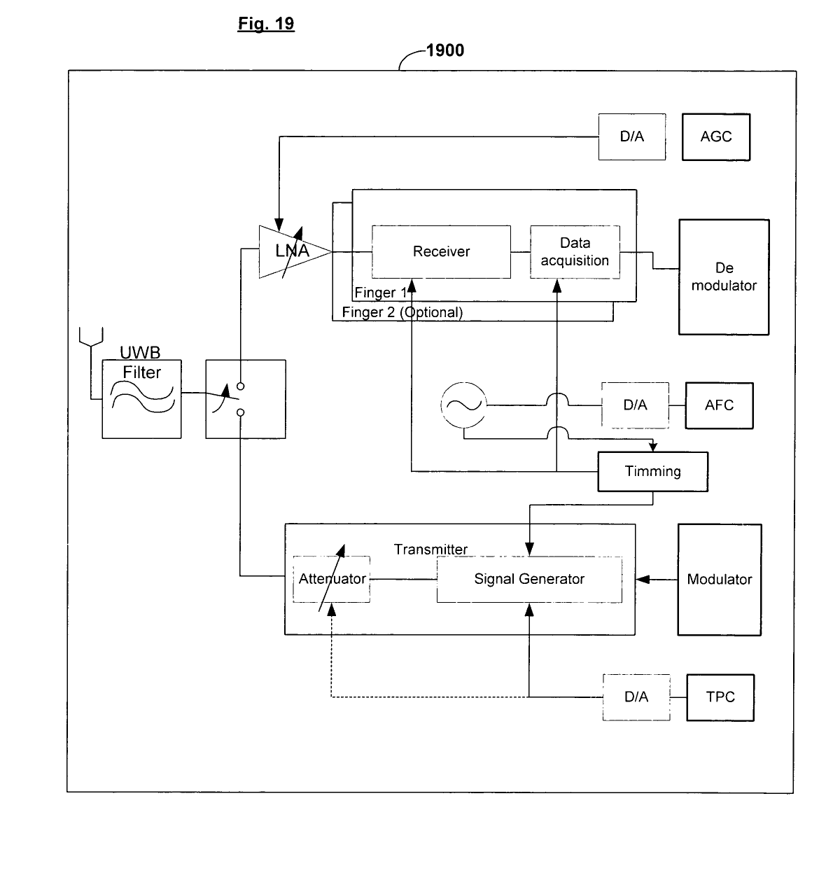

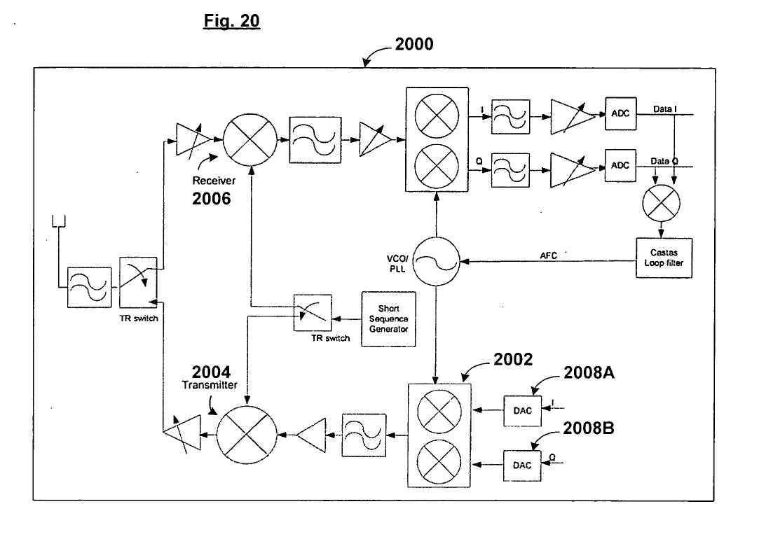

FIGS. 18-20 are block diagrams that provide examples of configurations and implementations of transceivers in accordance with some embodiments of the invention. FIG. 18 is a block diagram depicting an implementation 1800 of a transceiver, according to one embodiment of the invention. FIG. 19 is a schematic diagram depicting an implementation 1900 of a transceiver, according to one embodiment of the invention. In the implementation depicted in FIG. 19, the transceiver uses time division duplex technique, which can enable reuse of some elements of the transmitted signal (TX), or signal chain, and the received signal (RX), or signal chain. FIG. 20 is a schematic diagram depicting another implementation 2000 of a transceiver, according to another embodiment of the invention. Specifically, FIG. 20 depicts a full QAM transceiver, including a transmitter 2004 portion and a receiver 2006 portion. The transmitter 2004 portion of the transceiver includes a QPSK mixer 2002 and two DACs 2008A, 2008B. For example, using 16QAM, one of 16 sequences can be transmitted during an ON period, using 4 different amplitude levels on the I and Q. Using this technique, 4 bits can be mapped into one symbol, in accordance with the equation:

S=(A+2B) Sin+(C+2d) Cos

where S is the symbol, and A, B, C, and D are each bits having a value of +1 or −1. In some embodiments of the invention, I and Q carriers can be replaced by a wide band signal and a delayed version of the wide band signal in a transmitter and in a receiver. Additionally, in some embodiments, I and Q carriers can be replaced with a wide band signal and a 90 degree phase shift of the wide band signal (Hilbert transform) in a transmitter and in a receiver.

In some embodiments, the duration of each ON period and OFF period is adaptively changed in order to accommodate variable parameters, such as maximum power usage rate requirements, minimum data transfer rate requirements, range dictated requirements, or other parameters. For example, in some embodiments, the methods and systems of the invention can operate in different bit rate modes by varying ON and OFF period lengths or other parameters. For instance, In one embodiment, a low bit rate mode, middle rate mode and high bit rate mode are available. The low bit rate mode utilizes the following transmission parameters: a bit rate of 1 MHz, an ON period length of 10 nsec during which 10 chips are transmitted, an OFF period length of 990 nsec, a BPSK symbol modulation time of 1000 nsec, a chip rate of 1 GHz (chip time of 1 nsec), a carrier signal frequency of 4 GHz, and a signal spectrum of between 3 GHz and 5 GHz. The middle bit rate mode utilizes the following transmission parameters: a bit rate of 10 MHz, an ON period length of 10 nsec during which 10 chips are transmitted, an OFF period length of 90 nsec, a BPSK symbol modulation time of 100 nsec, a chip rate of 1 GHz (chip time of 1 nsec), a carrier signal frequency of 4 GHz, and a signal spectrum of between 3 GHz and 5 GHz. The high bit rate mode utilizes the following transmission parameters: a bit rate of 200 MHz, an ON period length of 5 nsec during which 5 chips are transmitted, an OFF period length of 15 nsec, a 16QAM symbol modulation time of 20 nsec, a chip rate of 1 GHz (chip time of Insec), a carrier signal frequency of 4 GHz, and a signal spectrum of between 3 GHz and 5 GHz.

In some embodiments, techniques other than 16QAM symbol modulation are utilized to provide high bit rate transmission. For example, in some embodiments, ON periods are utilized in which multiple bits are transmitted. In some embodiments, multiple bits are converted to a symbol, and a symbol is transmitted during an ON period, so that multiple bits are transmitted per ON period. For example, utilizing this technique, 200 MBPS rates are achievable, with 50 M sequences transmitted per second. In other embodiments, bits of information themselves can be transmitted in an ON period, instead of chips. For example, utilizing this technique, 100 MBPS rates are achievable by utilizing 10 nsec ON periods during which 10 bits are transmitted, 90 nsec OFF periods.

The methods and systems of various embodiments of the invention can provide numerous advantages over known wireless transmission systems. In some embodiments, transmitters and receivers, as described herein, use much less power than typical known systems utilizing DSSS. In some embodiments, transmitters and receivers and described herein operate utilize low power during ON periods and can utilize even less power during OFF periods by assuming very low power modes. In some embodiments, the methods and systems described herein provide better multipath fading resistance. In some embodiments, transmitters as described herein provide the advantage of much lower peak power usage, and more desirable peak to average ratios, as compared with typical known pulse transmitters. In some embodiments, as described above, the burst symbol cycle transmissions allow the use of a simplified and less accurate filter for ISI limitation as compared with non-burst symbol cycle systems, and also allow less accurate switch timing for a given specific performance. Additionally, the burst symbol cycle transmission techniques described herein provide advantages in a multiple access non-synchronization situations, including interference between signals intended for different users. It is to be noted that some embodiments of the invention are applicable to different multiple user applications or contexts, as described above.

FIGS. 21-26 are block diagrams that pictorially represent various configurations of digital devices and gateway servers, in which various embodiments of the invention can be utilized to provide multiple, simultaneous, high-speed data communications, utilizing burst symbol cycle UWB communications. As depicted, each server and digital device includes a transceiver to enable communication in accordance with the invention. In other embodiments however, where only one-way communication is required from, for example, a gateway server to a digital device, the gateway server can include a transmitter (and not a receiver) and the digital device can include a receiver (and not a transmitter).

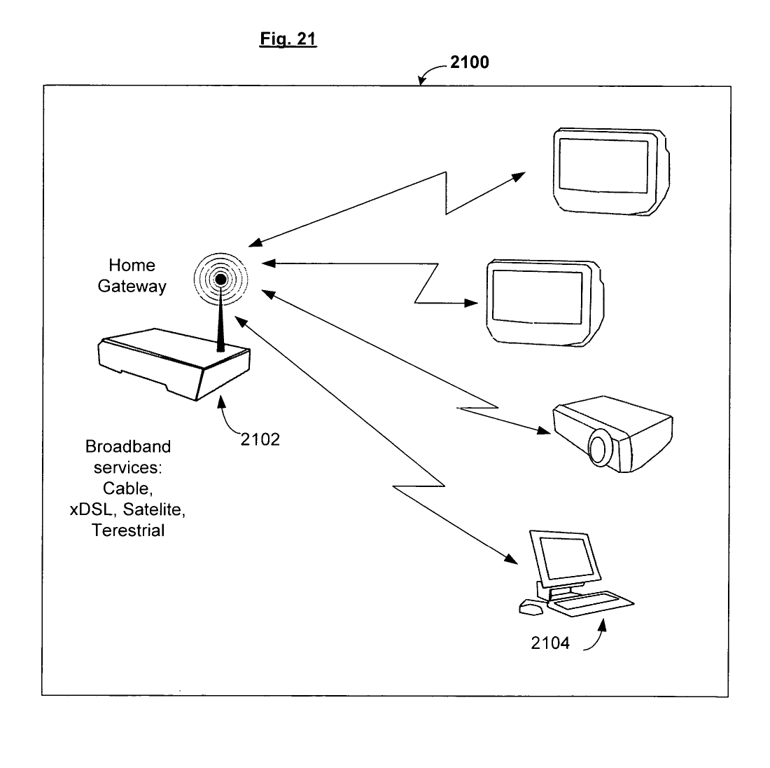

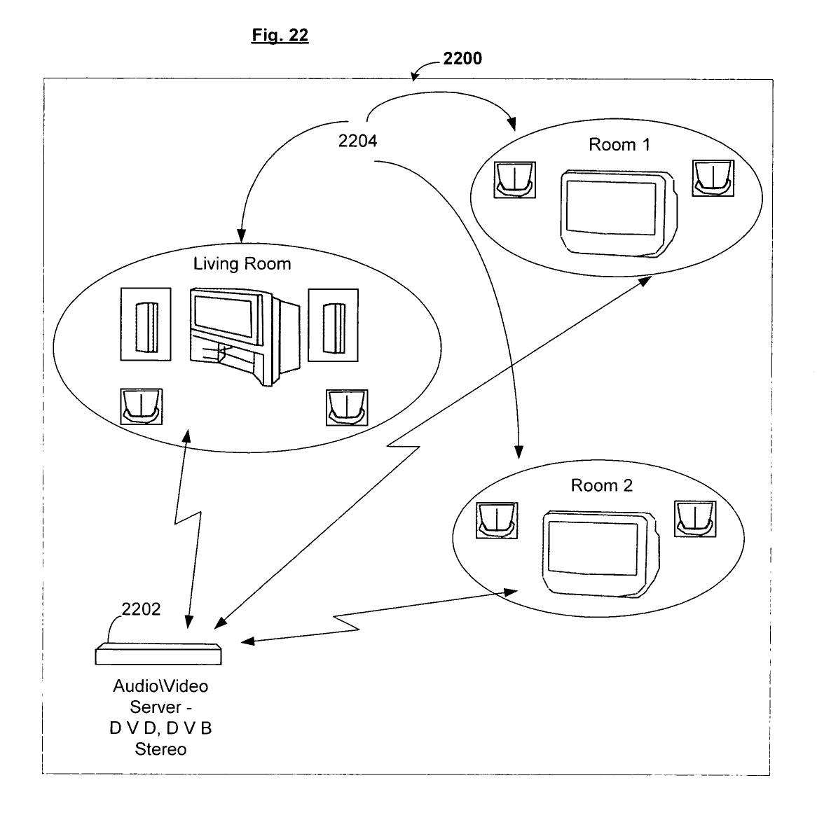

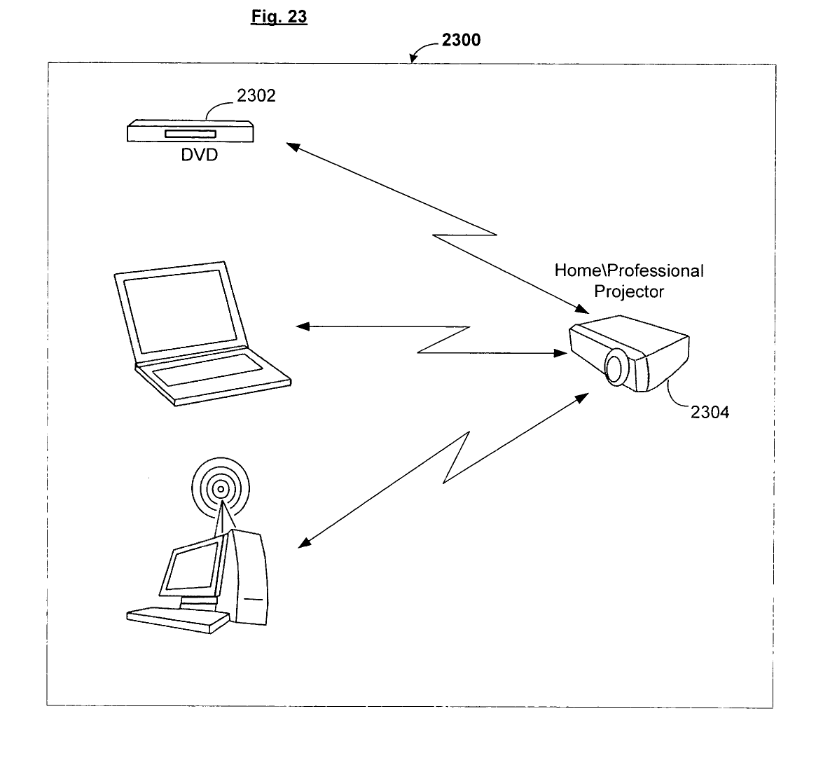

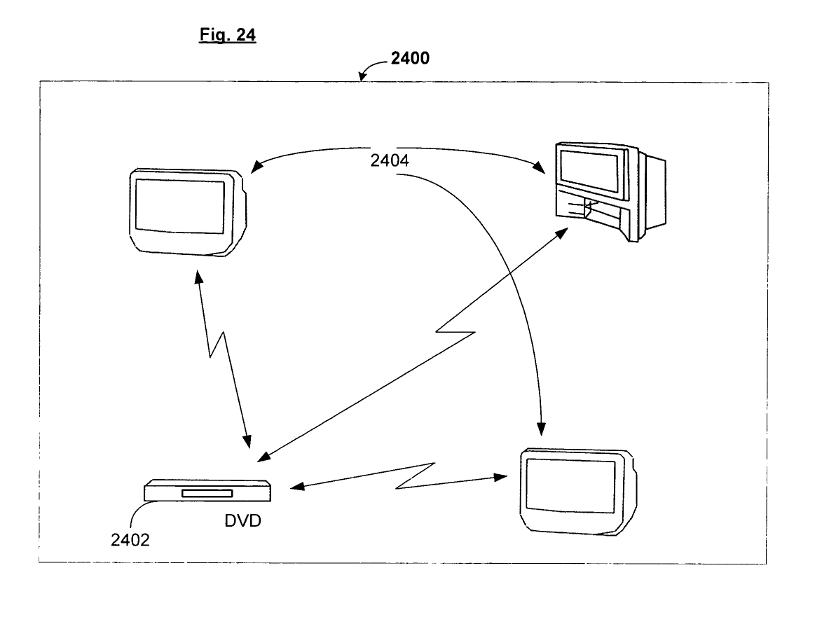

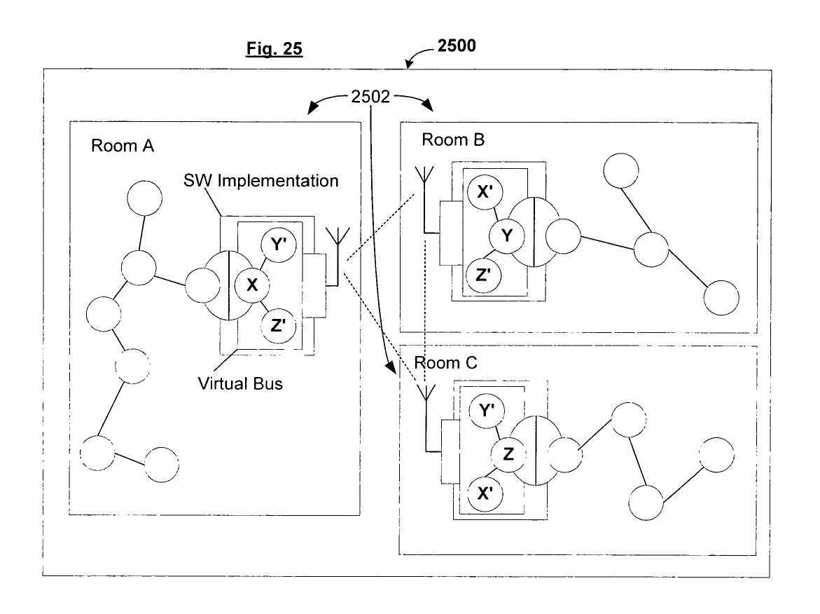

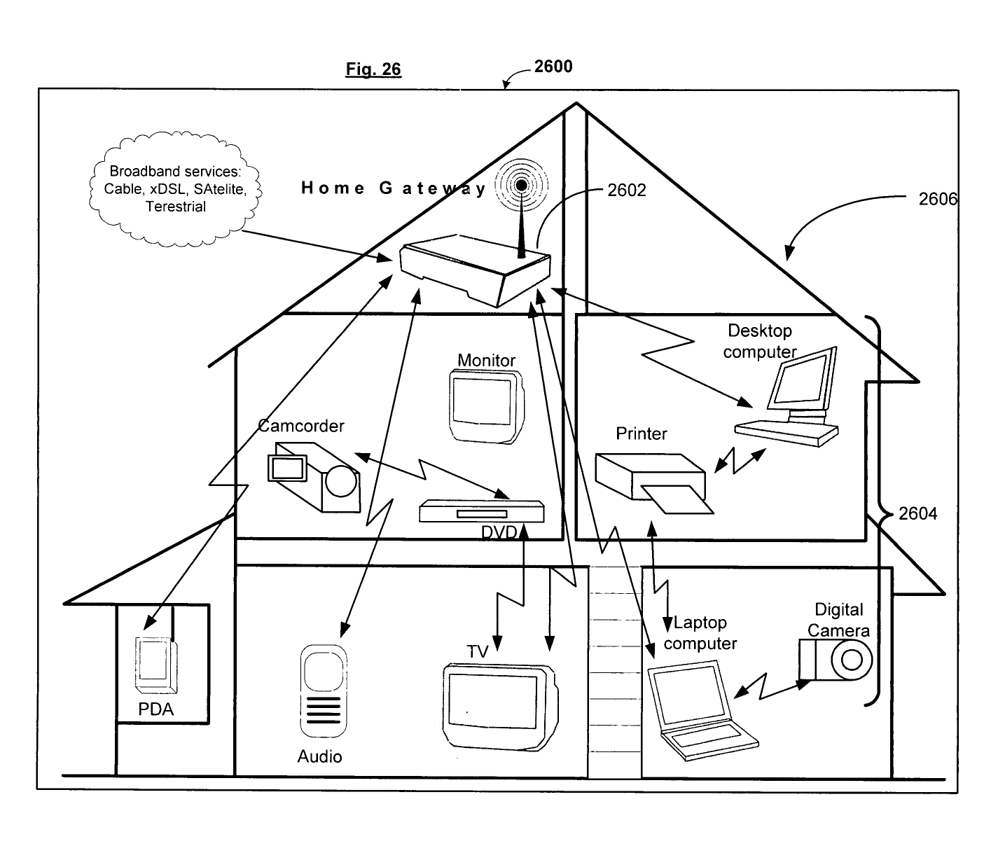

Specifically, FIG. 21 depicts a home gateway server 2102, which can, in some embodiments, be implemented as in a set top box configuration, connected to multiple digital devices 2104, according to one embodiment of the invention. FIG. 22 depicts gateway server which is an audio/video server 2202, connected to multiple audio/video digital devices in several different rooms 2204 of a house, according to one embodiment of the invention. FIG. 23 depicts multiple digital devices 2302, each connected to a projector 2304, according to one embodiment of the invention. The projector can, for instance, be utilized to provide large screen entertainment based on audio and visual data communication from the digital devices. FIG. 24 depicts a DVD player 2402 connected to multiple television sets 2404, according to one embodiment of the invention. FIG. 25 depicts a diagram of an in-building wireless network 2500 topology, according to one embodiment of the invention, spread between three rooms A-C 2502 of a building. FIG. 26 depicts a network 2600 including a home gateway server 2602 and numerous digital devices 2604 within a house 2606, according to one embodiment of the invention. As depicted in FIG. 26, some of the digital devices 2604 communicate with the home gateway server 2602, some with other of the digital devices 2604, and some with both.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

### Appendix 1

1. General

In some embodiments of the invention, different options are used to transmit high bit rate in an Ultra Wide Band system.

In some embodiments, options herein described have the advantages compared to known alternatives including the following: Dealing with interference; Less ISI; Channel energy collection; Better spectral shaping: A solution for Multiple Access; Fast synchronization; Tradeoff between better P/A (Pick to Average) and bit-rate.

Transmissions according to various embodiments of the invention can be in one of the three ways (FIG. 1 and FIG. 2):

1. Regular burst (as described in 0)

2. Repetitions in the symbol time, in order to improve the P/A.

3. Repetitions with codes on each repetition in order to improve the spectral shaping and additional separation for Multiple Access.

[image]

[image]

Burst Transmitting

A first solution is to collect few bits and transmit them in a burst as a fast sequence. e.g. transmit 100 MBPS using 10 nsec steams of 10 chips (which are the bits themselves) and having a silence for 90 nsec between them. (FIG. 3)

[image]

In some embodiments, with this solution, for multi user environment it can be needed to use random positioning for each sequence of bits because all the sequences are in use by each user, so there can be no way to separate between the users using coding.

Orthogonal Sequences

A second solution is to collect few bits and convert them to a symbol, where each symbol will be transmitted as a different sequence. e.g. having 16 different sequences, and transmit one of them for each combination of 4 bits, in this way 40 MBPS with 10M Sequences Per Second can be transmitted (FIG. 4). The sequence duty cycle can be as above 10 nsec on, 90 nsec off.

[image]

As can be seen this solution can be used, in some embodiments, mainly for a medium data rate like 40 MBPS, because with higher bit rate like 200 MPPS, it can be needed to use a mapping from 2\hat{ }16 to 2\hat{ }16 sequences, which will become to the bits themselves as in the first solution of the burst transmitting. In some embodiments, the Sequence should generally be selected with a maximal distance between them like Walsh-Hadamard (orthogonal sequences), or from other sequences like PN sequences, Barker sequences, Gold sequences or Kasami sequences.

OFDM Solution

A third solution is based on IFFT in the transmitter and FFT in the receiver like in OFDM transmitting (FIG. 5); the only difference is using discontinuous transmitting instead of continuous transmitting. The advantage is that the FFT rate is relatively lower then the FFT rate in continuous OFDM system.

[image]

A few bits will be collected like 8 in FIG. 6, each one can be +1 or −1, and convert them as they where a frequency spectrum into 8 digital values using IFFT. After a Parallel to Serial and Digital to Analog bursts will be transmitted of analog values, instead of digital as in the previous solutions. The transmitter can use a BPSK or QPSK modulation.

[image]

OFDM with Discrete Frequencies

In some embodiments, there is a simpler implementation of OFDM transmitter, where just part of the frequencies are used with minimal distance between them, a sequence of filters can be used in the transmitter and receiver instead of IFFT and FFT and implement non-coherent receiver, using energy detectors. (FIG. 7)

[image]

Two Planes Transmitting

More complex implementation is having frequency selection option like in 0 or 0, in addition to different burst position. When using this two planes, either part of the information in plane A and part in plane B is transmitted, or the same information in both planes is transmitted in order to gain diversity: resistance for both constant frequency interference and periodic time interference.

In each symbol time, few frequencies can be in the air, according to the OFDM mapping, in a different position according to the same information for the diversity or according to additional bits for having higher bit rate. (As described above) e.g. in FIG. 8, in this example the burst time is 20% of the symbol time, so there are 5 positions for the burst in each symbol time. In each symbol a pattern of frequencies is transmitted in a different position in the symbol.

[image]

Other Issues

In all the options described, a QPSK mixer can be used in the transmitter and in the receiver in order to multiply the maximum bit-rate by 2.

In the receiver, the input will be sampled with a longer window in time (FIG. 9), allowing collection of the multipath and implementation of a Rake receiver and/or equalizing for the channel.

[image]

In cases where the actual sample rate is around 1 GHz like when using the FFT, the system can see the entire spectrum, and can cancel interference by receiving the signal with notch on the interference.

A possible way for Multiple Access with all the option is random burst position.

What is claimed is:

1. A method for transmitting information, the method comprising:
transmitting, for a first period of time of each of a series of burst symbol cycles, one or more symbols, wherein each of the symbols comprises a bit sequence, and wherein each of the bit sequences maps to one or more bits of the information; and
suspending transmission for a second period of time of each of the series of burst symbol cycles.

2. The method of claim 1, comprising continuously transmitting each of the series of burst symbol cycles.

3. The method of claim 1, comprising, after transmitting the series of burst symbol cycles:
suspending transmission for a period of time between the series and a second series; and
after suspending transmission for the period of time between the series and the second series, transmitting the second series of burst symbol cycles.

4. The method of claim 1, wherein transmitting one or more symbols comprises transmitting one or more symbols using a phase modulation technique.

5. The method of claim 1, comprising, prior to transmitting the one or more symbols, mapping the one or more bits of the information to the one or more symbols.

6. The method of claim 1, wherein transmitting the one or more symbols comprises wirelessly transmitting the one or more symbols.

7. The method of claim 1, wherein transmitting the one or more symbols comprises transmitting the one or more symbols using wired transmission.

8. The method of claim 1, wherein transmitting one or more symbols comprises transmitting a wideband signal.

9. The method of claim 1, wherein transmitting one or more symbols comprises transmitting an ultra-wide band signal.

10. The method of claim 1, comprising determining a duration of each of the first and the second periods of time to correspond with desired transmission parameters.

11. The method of claim 10, wherein determining a duration of each of the first and the second periods of time comprises determining a duration of each of the first and the second periods of time to correspond with at least one of a desired power usage, a desired duty cycle, a desired data transfer rate, a desired interference susceptibility, a desired spectral mask, a desired spectral line set, and a desired chanellisation.

12. The method of claim 10, comprising determining a duration of each of the first and the second periods of time on a burst by burst basis.

13. The method of claim 10, wherein the series of burst symbol cycles comprises a first subseries and a second subseries, and comprising varying durations of periods of transmitting and periods of suspending transmitting, between the first subseries and the second subseries.

14. The method of claim 10, comprising, prior to transmitting the first series of burst symbol cycles, continuously transmitting a plurality of bit sequences.

15. The method of claim 14, comprising continuously transmitting the plurality of bit sequences in a preamble period.

16. The method of claim 1, comprising varying a bit sequencing technique between first periods of time of the burst sequence cycles.

17. The method of claim 1, comprising selecting transmission signal polarity to control spectral shaping.

18. The method of claim 1, comprising transmitting each burst in a different frequency.

19. The method of claim 18, wherein the frequency is selected according to at least one of the information and a pseudo-random sequence.

20. The method of claim 1, comprising transmitting each burst in more than one frequency.

21. The method of claim 20, wherein the frequencies are selected according to at least one of the information and a pseudo-random sequence.

22. A method for receiving information, the method comprising:
receiving, for a first period of time of each of a series of burst symbol cycles, one or more symbols, wherein each of the symbols comprises a bit sequence, and wherein each of the bit sequences maps to one or more bits of the information; and
suspending reception for a second period of time of each of the series of burst symbol cycles.

23. The method of claim 22, comprising, after receiving the one or more symbols, mapping the one or more symbols to the one or more bits of information.

24. A method for transmitting information, the method comprising:
translating a continuous signal into a series of burst symbol cycles;
transmitting, for a first period of time of each of the series of burst symbol cycles, one or more symbols, wherein each of the symbols comprises a bit sequence, and wherein each of the bit sequences maps to one or more bits of the information; and
suspending transmission for a second period of time of each of the series of burst symbol cycles.

25. The method of claim 24, comprising continuously transmitting each of the series of burst symbol cycles.

26. The method of claim 24, comprising, after transmitting the series of burst symbol cycles:
suspending transmission for a period of time between the series and a second series; and
after suspending transmission for the period of time between the series and the second series, transmitting the second series of burst symbol cycles.

27. A method for transmitting information, the method comprising:
translating a continuous signal containing the information into a second signal containing the information, the second signal comprising a series of burst signal cycles;
transmitting, for a first period of time of each of the series of burst symbol cycles, one or more symbols, each symbol comprising a bit sequence, wherein each of the bit sequences maps to one or more bits of the information; and
suspending transmission for a second period of time of each of the series of burst symbol cycles.

28. A method for transmitting information, the method comprising:
transmitting, using an ultra-wide band signal, for a first period of time of each of a series of burst symbol cycles, a plurality of chips; and
suspending transmission for a second period of time of each of the series of burst symbol cycles.

29. The method of claim 28, wherein transmitting a plurality of chips comprises transmitting one or more burst symbol cycles per one or more bits of the information.

30. The method of claim 28, wherein transmitting a plurality of chips comprises transmitting a plurality of chips using a direct sequence spread spectrum transmission technique comprising combining one or more pseudorandom sequences with a plurality of information bit sequences.

31. The method of claim 30, comprising utilizing a single pseudorandom bit sequence in transmitting every bit of the information.

32. The method of claim 28, wherein transmitting a plurality of chips comprises transmitting a plurality of chips using a binary phase shift keying modulation technique.

33. An ultra-wide band based wireless communication system, the system comprising:
a transmitter for:
transmitting, using an ultra-wide band signal, for a first period of time of each of a series of burst symbol cycles, one or more symbols, wherein each of the symbols comprises a bit sequence, and wherein each of the bit sequences maps to one or more bits of the information; and
suspending transmission for a second period of time of each of the series of burst symbol cycles; and
a receiver for receiving the transmitted symbols.

34. An ultra-wide band based wireless communication system, the system comprising:
a transmitter for:
transmitting, using an ultra-wide band signal, for a first period of time of each of a series of burst symbol cycles, a plurality of chips; and
suspending transmission for a second period of time of each of the series of burst symbol cycles; and
a receiver for receiving the transmitted chips.

35. An ultra-wide band based wireless communication apparatus, the apparatus comprising:
a transmitter for:
transmitting, using an ultra-wide band signal, for a first period of time of each of a series of burst symbol cycles, a plurality of chips; and
suspending transmission for a second period of time of each of the series of burst symbol cycles; and
a receiver for receiving the transmitted chips.

36. A system for ultra-wide band based communication between digital devices, the system comprising:
a first digital device comprising a first transmitter and a first receiver;
a second digital device comprising a second transmitter and a second receiver,
wherein the first and the second transmitters and the first and the second receivers facilitate communication between the first and the second digital devices, and wherein the first and the second transmitters are for:
transmitting, using an ultra-wide band signal, for a first period of time of each of a series of burst symbol cycles, a plurality of chips; and
suspending transmission for a second period of time of each of the series of burst symbol cycles; and
wherein the first and the second receivers are for receiving the transmitted chips.

37. The system of claim 36, wherein the system facilitates communication between each of three or more digital devices using burst symbol cycle transmission and reception.

38. The system of claim 36, wherein the first and second digital devices are at least part of a first cell, and wherein the system comprises a second cell, the second cell comprising:
a third digital device comprising a third transmitter and a third receiver;
a fourth digital device comprising a fourth transmitter and a fourth receiver,
wherein the third and the fourth transmitters and the third and the fourth receivers facilitate communication between the third and the fourth digital devices, and wherein the third and the fourth transmitters are for:
transmitting, using an ultra-wide band signal, for a first period of time of each of a series of burst symbol cycles, a plurality of chips; and
suspending transmission for a second period of time of each of the series of burst symbol cycles; and
wherein the third and the fourth receivers are for receiving the transmitted chips.

39. A method for transmitting information, the method comprising:
means for transmitting, for a first period of time of each of a series of burst symbol cycles, one or more symbols, wherein each of the symbols comprises a bit sequence, and wherein each of the bit sequences maps to one or more bits of the information; and
means for suspending transmission for a second period of time of each of the series of burst symbol cycles.
